(19) United States
(12) Patent Application Publication
(10) Pub. No.: US 2007/0233736 A1
(43) Pub. Date: Oct. 4, 2007

(54) METHOD AND SYSTEM FOR SOCIAL AND LEISURE LIFE MANAGEMENT

(75) Inventors: Rebecca Xiong, Cambridge, MA (US); Roy A. Rodenstein, Boston, MA (US); Geoff Menegay, Somerville, MA (US)

Correspondence Address: AKC PATENTS, 215 GROVE ST., NEWTON, MA, 02466, US

(73) Assignee: HEYLETSGO, INC., Boston, MA (US)

(21) Appl. No.: 11/691,999

(22) Filed: Mar. 27, 2007

Related U.S. Application Data
(60) Provisional application No. 60/787,474, filed on Mar. 28, 2006.

(51) Int. Cl. G06F 7/00

(52) U.S. Cl. 707/104.1

(57) ABSTRACT

A method and system for providing online management of social and leisure life activities. The method includes listing one or more events in an events database, listing profiles of one or more users in a users database and linking information from the events database to the users database based upon the users profile information. The method also includes planning and coordinating social or leisure activities for and among the users. The events database and the users database are accessible via a network connection to a website.

### CROSS REFERENCE TO RELATED CO-PENDING APPLICATIONS

This application claims the benefit of U.S. provisional application Ser. No. 60/784,474 filed on Mar. 28, 2006 and entitled METHOD AND SYSTEM FOR SOCIAL AND LEISURE LIFE MANAGEMENT which is commonly assigned and the contents of which are expressly incorporated herein by reference.

### FIELD OF THE INVENTION

The present invention relates to a system and a method for social and leisure life management, and in particular to an online system that helps users effectively manage their social and leisure activities together with friends and other people.

### BACKGROUND OF THE INVENTION

Social and leisure life activities occupy one-third of a person's waking life. Traditionally a person manages social and leisure activities by finding fun things to do, planning and coordinating things together with other people and friends, and staying connected with friends. The emergence of the virtual community of the World Wide Web (www) has allowed people to form online groups, to meet new people and to stay connected with each other. The World Wide Web has also allowed online promoting and listing of events, programs and schedules and facilitated selling of tickets and reservations for these events and programs. Previous socially directed online systems focus on such event listings, restaurant and theater reviews, or social networks for connecting people, or electronic invites systems. There are also prior art meeting planning tools or group interaction tools, but most of them are directed at work rather than play. However, simply looking at event listings by themselves or just having a list of one's friends are insufficient for managing one's leisure activities. It is important to note that one usually decides what to do based on a combination of what's interesting to do and what ones' friends want to do.

Accordingly, there is a need for an online system and method that helps users effectively manage their social and leisure activities by finding fun things to do, planning and coordinating things to do together with friends, and staying connected with their friends.

### SUMMARY OF THE INVENTION

In general in one aspect, the invention features a method for providing online management of social and leisure life activities including providing a website, listing one or more events in an events database, listing profiles of one or more users in a users database and linking information from the events database to the users database based upon the users profile information. The method also includes planning and coordinating one or more social or leisure activities for the users. The website is accessible via a network connection and comprises a plurality of interlinked webpages stored in a memory and the memory is coupled to a computing circuit and to a communications interface for communicating via the network connection. The events database and the users database are accessible via the website. The users profiles comprise information about the users interests, preferred activities and network of friends.

Implementations of this aspect of the invention may include one or more of the following features. The leisure activities are planned and coordinated for a group of users. The listing of events includes posting events by users or gathering event listings from external data feeds and displaying the event listing in the website. The gathering of event listing includes crawling external websites, identifying event URL address, name, date, time, venue, event description and cost information, checking for a duplicate event and listing the event in the event database if no duplicate event exists. The external data feeds may be structured data feeds, unstructured data feeds, RSS or XML. The method may further include removing duplicate event listings from the external data feeds. The method may further include assigning an identification feature to each event listed. The identification feature may be a URL address pointing to an event webpage, a number, a name or combinations thereof. The events database includes event data organized in a canonical structure of categories and subcategories. The events may be concerts, live music, arts, cultural events, social and community events, sporting events, outdoor activities, recreational activities, professional and business events, or private parties and gatherings. The events database includes listing of event name, time, venue, event description, cost information, artist background information, reviews, transportation information, proximity to other events information, links to additional information, user comments or recurrence information. The method may further include logging into the website via a secure login mechanism, browsing user profiles listed in the users database and/or browsing events listed in the events database. The method may further include communicating with users listed in the users database. The method may further include assigning visibility privilege to each listed events. The visibility privilege may be public, my friends and their friends, my friends, select friends, select group, or private. The events may be displayed in lists such as today's events, next 7 days events, upcoming events, events posted by friends, events posted by group members, top picks, editor's picks, more for today, user's wish list, recommended based on user's interest or users group events. The method may further include comprising assigning and displaying a buzz level to each event. The buzz level is a measure of the events popularity calculated based on number of viewings, number of unique viewers, number of users placing the event in their wish lists, number of users making plans to attend the event, number of users having attended the event, ratings of the event, whether event is one-time or ongoing, and how soon it will be over. The method may further include entering a rating for an event or a venue by the users. The method may further include subscribing to a specific user's wish list. The method may further include providing personalized events to a user based on the user's profile or on collaborative filtering techniques. The method may further include sending e-mails to users with personalized event suggestions. The method may further include uploading text and images onto a users profile. The method may further include inviting the users to join a group with common interests or inviting the users to attend an event or a leisure activity. The event planning and coordinating for a group of users may be done by a facilitator. The method may further include providing an online link to a ticket purchasing system for events and a ticket engine for finding the best price from available ticket sites. The method may further include keeping track of users registered to attend an event. The method may further include promoting events to users based on their profile information. The method may further include providing dating services among the users. The method may further include providing advertisements to the users.

In general, in another aspect, the invention features a system for online management of social and leisure life activities including a website, means for listing one or more events in an events database, means for listing profiles of one or more users in a users database, means for linking information from the events database to the users database based upon the users profile information and means for planning and coordinating one or more social or leisure activities for the users. The website is accessible via a network connection and comprises a plurality of interlinked webpages stored in a memory and the memory is coupled to a computing circuit and to a communications interface for communicating via the network connection. The events database and the users database are accessible via the website. The users profiles comprise information about the users interests, preferred activities and network of friends.

In general, in another aspect, the invention features a method for providing online management of social and leisure life activities including providing a website, gathering event listings from external data feeds, removing duplicate event listings from the external data feeds thereby generating unique event listings and then listing the unique event listings in an events database. The website is accessible via a network connection and comprises a plurality of interlinked webpages stored in a memory and the memory is coupled to a computing circuit and to a communications interface for communicating via the network connection. The events database is accessible via the website.

In general, in another aspect, the invention features a method for providing online management of social and leisure life activities including providing a website, listing one or more events in an events database, listing profiles of one or more users in a users database and assigning a buzz level to each event. The buzz level is a measure of the events popularity calculated based on number of viewings, number of unique viewers, number of users placing the event in their wish lists, number of users making plans to attend the event, number of users having attended the event, ratings of the event, whether event is one-time or ongoing, and how soon it will be over. The website is accessible via a network connection and comprises a plurality of interlinked webpages stored in a memory and the memory is coupled to a computing circuit and to a communications interface for communicating via the network connection. The events and the users databases are accessible via the website.

Among the advantages of this invention may be one or more of the following. The system brings together all the necessary elements for social and leisure life management and puts together the right combination to fully address the problem. These key elements include listings of events, fostering online interactions among groups of friends and linking events and leisure activities to social network of users for leisure life management. By providing an engaging, personalized view of local activities, a sticky destination website is created; by facilitating activities among groups of friends, the viral growth of social networks is leveraged; by learning users' interests in various activities, accurate behavioral user profiles are created. These rich user profiles are applied to products for advertisers and event promoters, giving them a uniquely accurate targeting channel to reach specific user demographic in the positive context of the activities they actively engage in. The present invention offers users the activity information and social coordination tools they need to manage their leisure life. Key components help them to do the following
Find and track things they want to do
Determine friends' interest and availability to plan activities
Purchase tickets and coordinate logistics
Learn from community-generated popularity, ratings and discussions
Meet others with shared interest for activity partners, friendship and dating
Record and share engaging social diaries with pictures of their activities
Activity aggregation—for providing comprehensive listings by automatically crawling, extracting, merging and enriching multiple sources of data.
Intelligent event prioritization—for automatic discovery of the most important and relevant activities, based on personalization technology similar to collaborative filtering

One implementation of the system is a Website, although these ideas can also be applied to other implementations such as a client-server program, and a mobile phone or handheld extension. The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

FIG. 1 is an overview of the present system;

FIG. 2 illustrates the process of crawling web pages for collecting events;

FIG. 3 illustrates the de-duping process with user input;

FIG. 4 depicts a screen for posting an event;

FIG. 5 depicts a screen for sending an invite;

FIG. 6 depicts a screen for user-posted events;

FIG. 7 shows events listings for a given day on the Home Page;

FIG. 8 shows the full events listings;

FIG. 9 shows a weekend view of the events listings;

FIG. 10 depicts an event page;

FIG. 11 depicts a movie page;

FIG. 12 depicts a venue page;

FIG. 13 depicts a restaurants page;

FIG. 14 depicts an artist page;

FIG. 15 depicts a wish list page;

FIG. 16 shows friend's picks for today and friends latest picks;

FIG. 17 depicts the top picks among friends;

FIG. 18 shows the calendar and wish list view;

FIG. 19 shows a personalized weekly update;

FIG. 20 shows the friends' update box;

FIG. 21 shows an update blog;

FIG. 22 shows a photo album created from updates;

FIG. 23 shows a screen for inviting friends to the website;

FIG. 24 depicts a screen for suggested friends;

FIG. 25 shows a suggested friends box;

FIG. 26 shows an invite friends status report;

FIG. 27 depicts a compact friends page;

FIG. 28 depicts a detailed friends page;

FIG. 29 shows a “New for you notifications”;

FIG. 30 shows a group page including a sub group, group members, comments, group events, and top picks;

FIG. 31 shows top events including which group each event belongs to;

FIG. 32 shows a member recognized for being the first finder and poster for an event on their wish list;

FIG. 33 shows a people to meet screen; and

FIG. 34 shows a sample invite with profile pictures and responses from guests.

### DETAILED DESCRIPTION OF THE INVENTION

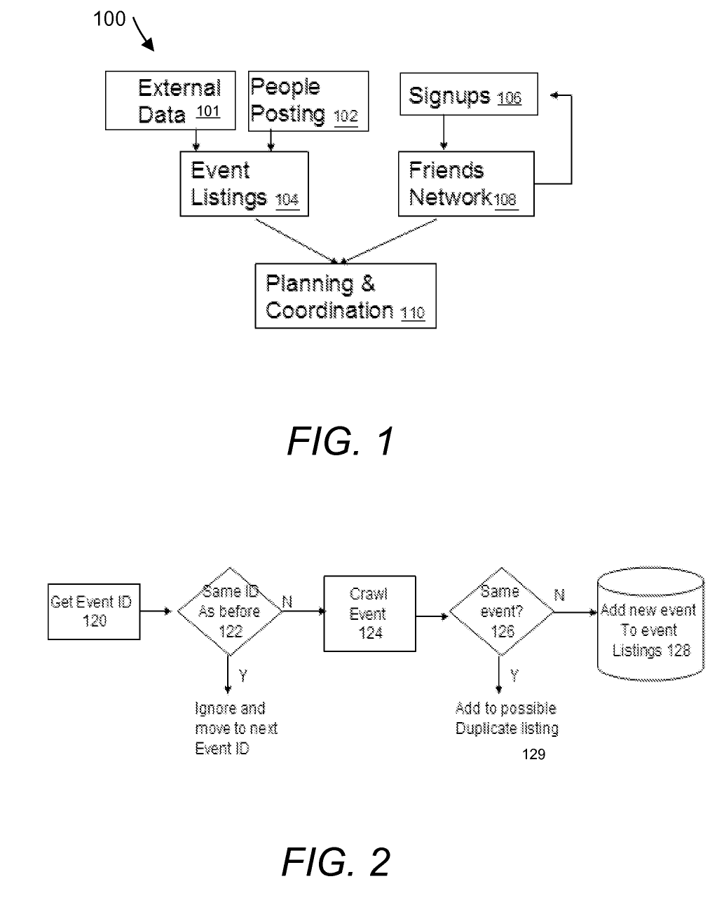

Referring to FIG. 1, the system for social and leisure management 100 includes event listings 104, friends network (or people profiles) 108, and tools for planning and coordination around activities 110.
Event listings—gathering and displaying event listings, allowing users to input their own events as well as posting events
Friends network—Means for people to describe themselves in a detailed profile, specify their friends, find friends' friends, browse profiles, invite more of their friends to join and fill out their profiles, messaging and communication, create groups, identify others of interest.
Planning and coordination—where activities and people come together. Identifying people interested in same activity, figuring out availability, electronic invites, and social calendaring, and after the activities sharing the experience with friends through updates and pictures.

This overview diagram helps to distinguish our system from existing systems. Many of the existing systems concentrate on one of the three boxes, i.e., event listings 104, friends network 108, or tools for planning and coordination 110, while our system is the first to combine and do all three in depth. For example, CitySearch's Events section only does Event Listings; Friendster and Thefacebook only do social networking, and electronic invite and social calendaring sites primarily focus on planning.

There are some sites that are focused on one box and have some basic features of the other boxes, but miss key features of the other boxes necessary to create a social and leisure management system. For example, Upcoming.org, a user-contributed global event calendar, also has some people features for creating profiles and specifying friends. But there's no invite friends capability to grow the network; the profiles contain minimal information, and one can't see friends' friends. These profiles are primarily designed to show some information about event posters. It doesn't provide enough people functionality to make one want to get all ones' friends into the system. There are also no planning and coordination capabilities.

Similarly, Evite, an electronic invite system, has some listings of public events created by users, and allows users to create a profile. The focus, however, is on an electronic invite system- only one part of the planning and coordination box. Profiles are not browsable by other users, giving very little incentive for people to create full-blown profiles. Furthermore, the dependence on users inputting events for both of these systems limits the number of event offerings and their attractiveness to a broader audience.

In contrast, our system is designed to manage all one's social events and one's friend network, as well as for coordinating and going to these events with friends. By starting with a large set of events through external feeds (100) and a strongly connected and growing network of friends' event listings (108) easily browsable by users, our system greatly encourages individuals to post events, to sign up other users, fill out rich profiles, learn more about friends and their friends, and to coordinate (110) and go to more of these events with friends.

We will now go through the three areas of the system one by one. Event listings 104 include events and activity data that can come from external data feeds 101 or postings from users 102. Event types can include concerts, live music, arts and cultural events, social and community events, sporting events, outdoor activities and other recreational activities, professional and business events, and private parties and gatherings. An external data feed 101 provides a much bigger selection of events overall than those input by the users alone. There are sources that make event listings available as RSS or XML feeds, which are structured data feeds that can be easily parsed by a computer program. In addition, some Web sites have unstructured event listings that are designed for display by Web browser, and thus not easily parsed. Our system is capable of incorporating event listings from multiple sources and removing duplicates through both automatic and semi-automatic approaches. Challenges we address are:
1) Extracting event details, such as event name, time and venue, from unstructured text or HTML
2) Removing duplicate events that appear in multiple sources (could also be same source with multiple listing for same event)
3) Putting data in format usable by our system, such as mapping from a different categorization system to ours.

When 3rd parties describe real-world events or locations, they do so in different ways, often with differing details. Our system aggregates the disparate information sources such that the relevant information from each is combined and displayed together. Our method of aggregating different information sources relies upon uniquely identifying each new description of an event by an ID, and creating and adding to an authoritative record. Our system uses a relational database for information storage and retrieval. When a duplicate event is found, whether from a single source or from multiple sources, an entry is made in a database table that records source ids and maps them to the single “official” record which serves as the aggregation of those several source IDs.

For extracting event information from the web, we typically start with a large listing of events, each with its own unique ID. For a clean data set, the same event ID should indicate it being the same event. And any new information can replace or be added to an existing record.

Data in Web listings can unfortunately be quite noisy. The event ID in this case is a URL pointing to an event page. In one case, we found that the same URL indicates the same information, but multiple URLs from the same source may actually contain information for the same event. This is due to updates to events being simply created as a new event. Web event listing are typically in the form of a page containing a listing of events, such as a page listing all upcoming events, or a search result page with no criteria specified, matching all the listings. When crawling the same site over two different time periods, we need to determine whether a particular event listing is one we've already seen before. And when we crawl multiple sites, we need to determine if two event listings from two sites actually refer to the same event. The algorithm is as shown in FIG. 2.

When crawling events (124) from unstructured content such as HTML or text event listings, one needs to specify where in the HTML document each piece of event information resides, such as event name, date, time. Next, we determine whether a new event listing is the same event (126) as one already in the database by several factors: whether they contain the same words and are taking place in the same venue. Other event information, such as time, cost, description, can change. Once events are added to the possible duplicates listings (129) they can then be semi-automatically de-duped and added to the database. The process in FIG. 2 can be automatically scheduled to run to add new non-duplicate events into the database, while the suspected duplicates, only a small fraction, can be processed with human intervention later. One small variation on 129 is that if two events have exactly the same basic info (name, venue, date, cost) but just different descriptions, they can be automatically merged as the same event, but with both descriptions referencing the same official record. (In the database, there is one table for events, and another for event description.) This is a great way to get more information about an event from multiple Web sites.

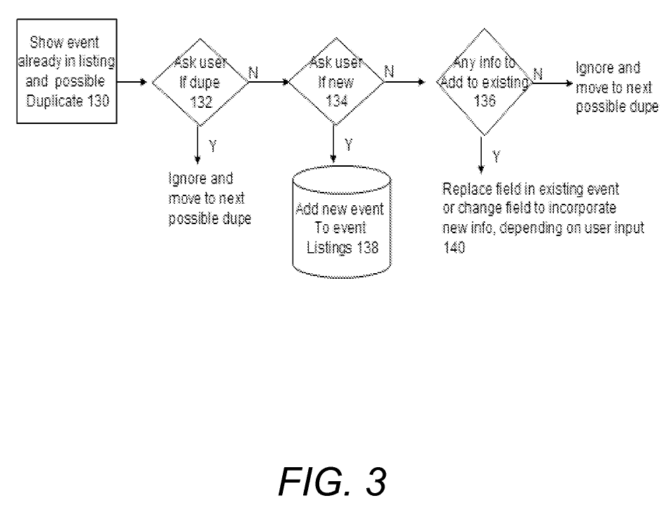

FIG. 3 shows event processing and the semi-automatic process for merging possible duplicates into the database, a process we refer to as de-duping. The program goes through each possible dupe, shows it to the administrator along with the event already in the database, and asks the administrator for a decision. If it's a full duplicate (132) it's ignored; if it's not a duplicate (134) it's added to the database, and if it is a duplicate but contains information not already in our records, such as new showtimes for an event or a better name for the event, then the appropriate information is either added or replaces the data already in the database.

The same process is first applied to venues: venues are crawled, and potential duplicate venues are set aside, while non-duplicate venues are added into the database. The criteria for determining whether two venues are the same is whether the address is the same, and the venue names contain similar words. The semi-automatic de-duping process is executed for potentially duplicate venues. A table is used to match venues to all the different IDs from different sources, as is done for events. This is how the system can tell that two events from two different data sources are referring to the same venue. More criteria for automatically determining whether two events or two venues are the same can be added to 126, so that different events can be added to the database without human intervention. If the system determines that two events are the same, it can automatically update the master event record with additional data- for example, if a duplicate event is found that has an end date later than the current master event has, the end date is extended on the master event record. Through the automated deduping process, the remaining set of possible dupes that have to be semi-automatically de-duped becomes much smaller.

For listings with known structure such as RSS or XML feeds, the system utilizes a program to extract information from structured data type by field, such as event name, location, start date and time, end date and time, event descriptions, and cost.

We allow users to search by category and subcategory of events, such as Music and “pop and rock”. This means each event needs to have a category, and if possible also a subcategory. For each external data source, we need to map their set of categories, if any, to our categories and subcategories. For example, one source may use Pop Music as a category, while our master Category records have a Music and a Pop and Rock subcategory. This can be done through a category mapping record per data source.

Alternatively, if there are overlapping events between two data sources, one can also map categories based on the overlap. E.g., if a new source has “Music—Jazz”, and there is already an existing category “Music—Jazz & Blues”, and over a threshold of 80% of the overlapping events in the former are in the latter, then we can map one to the other. Finally apply human inspection.

Our canonical categories are fairly broad, making it suitable for this strategy. However, if the source only has a very broad category, say Music, a different strategy is needed. One can look at the venue of the event to guess at the category of music. A venue that consistently has jazz and blues probably means the event is jazz and blues. Of course, some venues have events of different categories. These can be added to the manual categorizing bin and be subject to human review. Finally, we allow users to flag “wrong category” and specify the new category as a way of suggesting a correction to the data. The flagging is shown to other users as a warning. Human review is required for actual changes.

To provide more information on events, we also need to gather other types of data. For a concert or an art exhibit, information about the artist can be very helpful. This can be obtained by crawling or obtaining artist listings, which may include a musician's albums and songs, or for an artist where he has exhibited. To connect the artist to the event, we apply several heuristics. The simplest is exact match. If that fails, we then try for “X, Y” event to look up artists X and Y separately. Other forms include “X and Y”, “X & Y”, “X with Y”, etc. Additionally, we check substring matches of artist names within event titles.

Restaurant information is important for two reasons: people often want to find restaurants near an event, and going to a restaurant can be an activity on its own. When crawling restaurants data, the same issue of merging with existing data emerges, for restaurant/bars that also host events. They can be matched with existing venues by exact matches of the names, then exact address. Next we try substring matches and allow an administrator to override.

Another source of activities is events that users post themselves. They are useful both because external event listings may not have sufficient coverage tailored for an individual (especially for parties or smaller events), and because people tend to be most interested in events their friends are already interested in. The challenges are
1) Making it easy for users to posts events
2) Allowing for different variants of event postings
3) Allowing different visibility and privacy for events

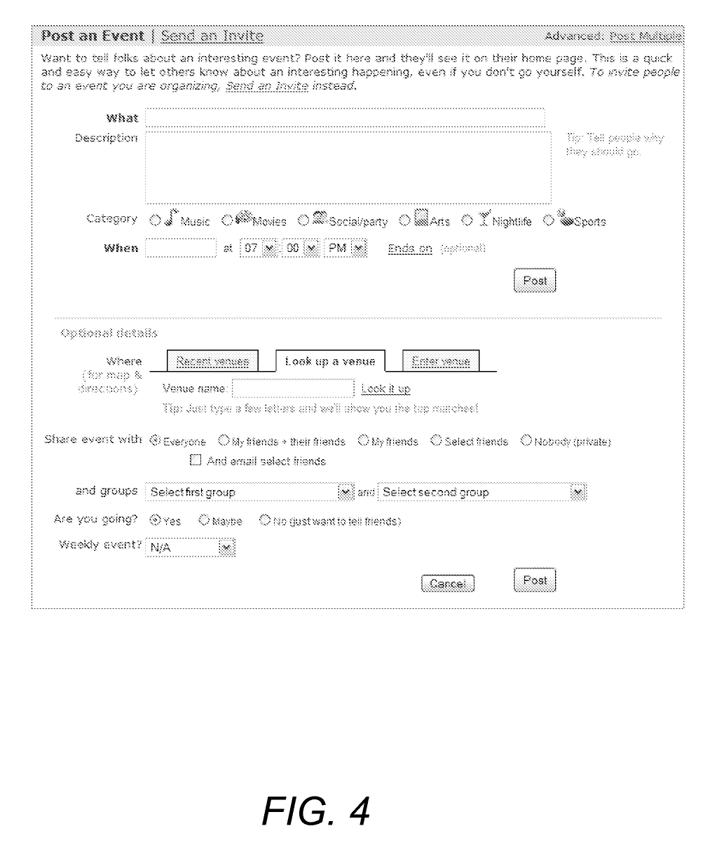

For users, there is a range of different types of event postings, from simply wanting to tell friends about an interesting event they heard about, to actually making plans to meet up with people or inviting people over. As a result, we provide two separate user interfaces. The Post an Event screen, shown in FIG. 4, for telling friends about a cool event or promoting an event to everyone that the poster is not necessarily organizing, or for an event they are organizing that is open to the public at large. For ease of event posting, only minimal information is required, such as name and date. The screen also offers rich functionality in case the event poster wants to provide more info, such as the venue (either by looking up the name, or by entering a new venue if the venue isn't in the system), weekly recurrence (e.g. happens every Saturday at 8 PM).

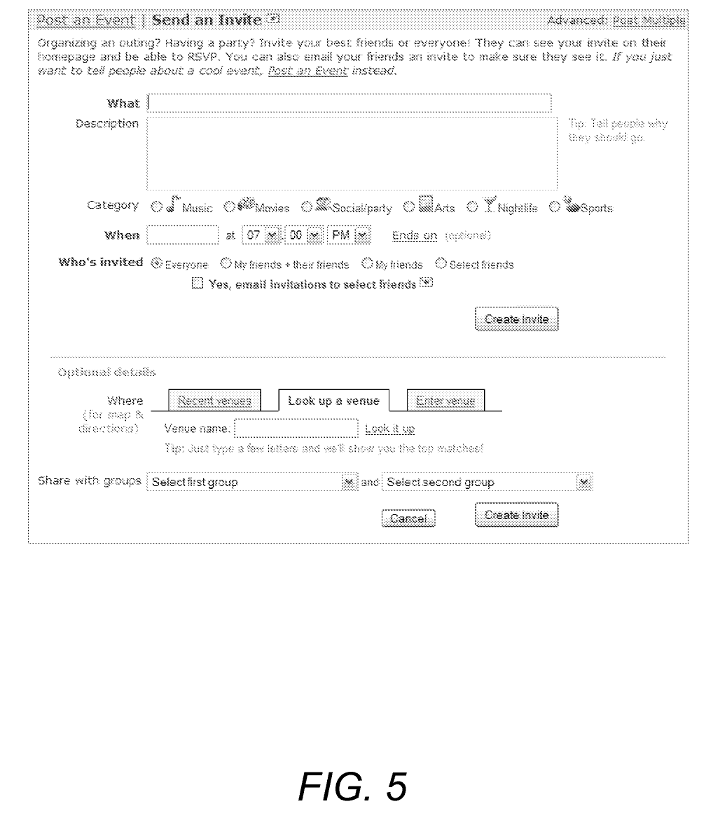

The Send an Invite screen, shown in FIG. 5, is designed more for an organizer inviting others to a private party or a trip together. Notice the prominence of the Who to Invite field box, and the send email invite check box. Users are more likely to send emails for an event they are personally organizing to ensure people see the invite.

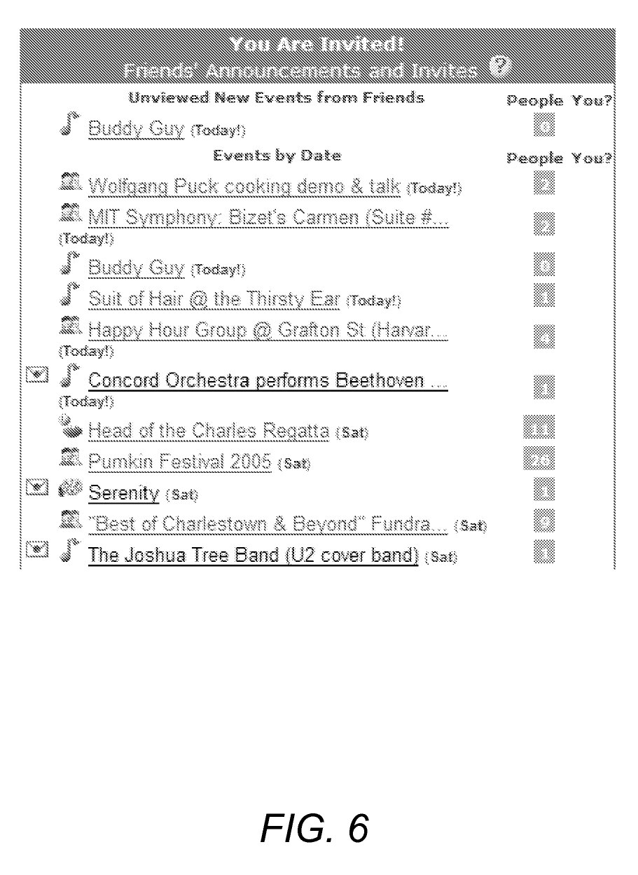

Invites are then highlighted to invitees in our event listings with an envelope icon, as shown in the example in FIG. 6.

Visibility is a key part of event posting. Some events one may want everyone to know about, others just a few select persons, still others may be entirely private appointments. We allow users to specify visibility as public, friends and their friends, friends, select people, and private (only visible to self). We then show events only to people who are allowed to see them. This follows how in real life, information about events spreads through word of mouth, but we give people an easy to way to modulate how much they want to spread the news. We also allow users to show the events to a wide group, such as friends and their friends, while only sending email to a narrower set, such as few people who the user really wants to come. That way, they won't be spamming people unnecessarily, can just let the people who they think are interested in an event be notified by email; but at the same time gives them a chance for others in their friend network to find out about the event if they are interested.

After getting events in the system, displaying the events also presents numerous challenges. The goal is to make it easy for a user to find things they'd like to do. On any given day, our system has hundreds of events available in any metro area. It's hard for a user to find interesting events from just a plain list. We have several approaches to addressing this problem:
1) An easy to navigate GUI for viewing the “top” events
2) Filtering events by specific criteria
3) Buzz level to show events in an organized way that highlights popular events
4) Personalization based on users' stated interests
5) Personalization based on collaborative filtering
6) Wish lists of activities to do and sharing of wish lists
7) Making it easy to get more information about events

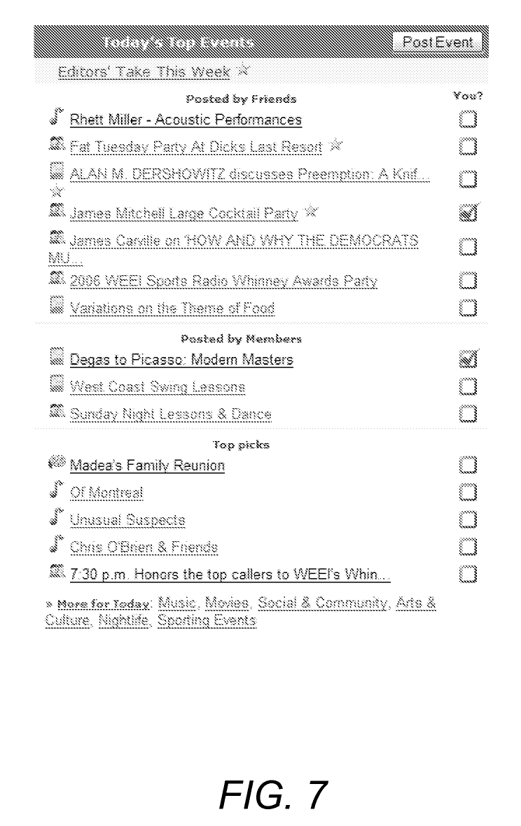

The system allows the user to easily view events. The Home page shows three sections of events, for Today, Next 7 days, and Upcoming. All three show public events combined with any private events visible to the user. The Today view is as shown in FIG. 7. First, events posted by friends are listed, which are typically the most interesting to a person; next are editors' picks, which can be for either user-posted events or events from external listings; then events posted by broader members of the community are displayed; and finally top picks from external (non-community posted) event listings. Gold stars indicate all the editors' picks. Below the event listings is the “More for Today” list, showing links to all the public events (see below) by category. So users can easily tap into hundreds of music, arts, sports, and other types events for the day. Icons to the left of event names provide some info about the type of event, whether Music, Arts & Culture, and the like. The Next 7 day and Upcoming sections work the same way, but for a longer time period.

In addition, other events specifically added by the user to their Wish List, events from Groups the user is a member of, and events recommended to the user based on their interest are shown in separate sections. This creates one place for users to view all the events they are most like to be interested in. The same view can also be displayed in calendar format.

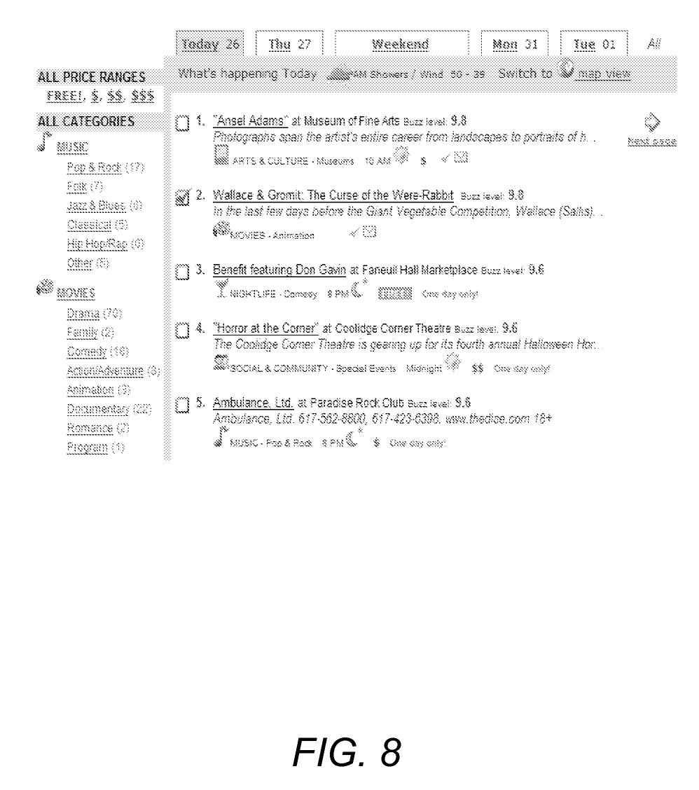

On the Public Events Page, publicly viewable events posted by users are merged with events from external data sources and displayed together, as shown in FIG. 8. The user can use the Day tabs on top to navigate among the days, the price range selections on the left to view only free or cheap events, and also from the left, pick among different categories and subcategories of events. If a user selects both FREE and Music-Pop & Rock, then only events in that subcategory and are free will be shown for the selected day.

Note on the left the number in parentheses after each subcategory. This indicates the number of events in that subcategory based on day and price selections. This gives users a sense of where there are more events to look through.

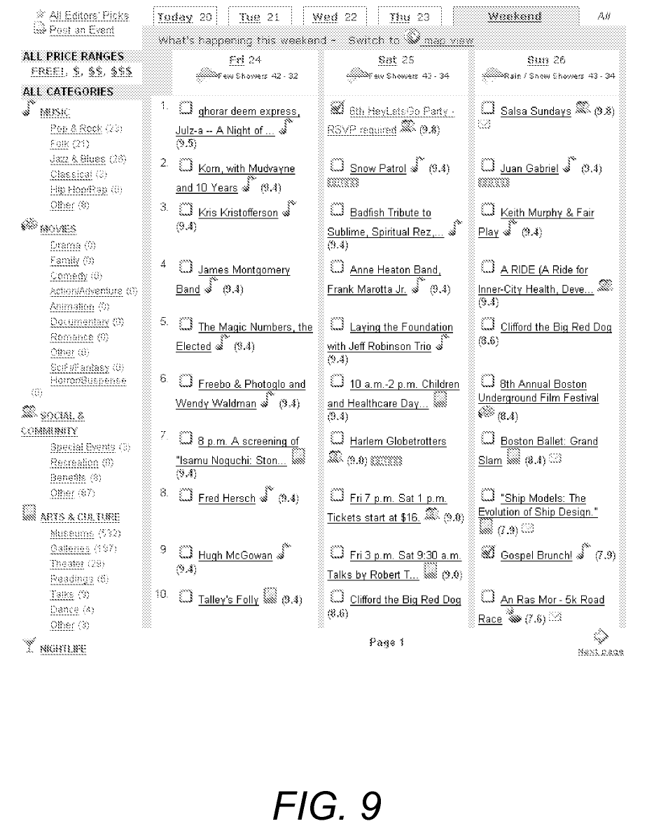

FIG. 9 shows another view of event listings, the weekend view, where events from Friday, Saturday and Sunday are shown in a summary view, to help people better plan their weekend. The user can still click on an individual day to get the full view of a specific day. Note on the bottom of FIG. 9 the “Next” arrow to enable the user to view more listings for that weekend or day.

For each day, there can be hundreds of events. It's important to help users sort through the listings both by applying filters as above but also by listing events in order by what's most interesting. In both FIG. 8 and FIG. 9, the events are listed in the order of greatest Buzz Level to lowest buzz level, as indicated by the label buzz level in FIG. 8, and in parentheses after the event name in FIG. 9. The Buzz Level of an event measures the interesting-ness of an event to the general population. It is computed by looking at a range of factors including how often the event has been viewed, how many different users have viewed it, how many people put it on their wish list to make plans around it, how many people put it on their done list to indicate they've gone, the rating of the venue that the event is taking place at, whether it's a one-time event or ongoing, how highly it was rated, and how soon it will be over.

For each of these factors, we assign a score between 0, lowest, and 1, highest to each event. For example, an event that has been viewed the most in a month is assigned a score of 1, and an event that has not been viewed at all will be assigned a score of 0, for the views factor. Similarly, a one-day only event gets a score of 1 and an ongoing event that lasts for 2 months gets a score of 1/60 on the duration factor. An event at the most popular venue, such as a major concert hall or the city hall, gets a score of 1 on the venue factor, while an event at a less popular venue, such as a small church or high school auditorium gets a score based on its venue's popularity which will be closer to 0. Then a weight is assigned to each factor, such as weight of 1 for venue popularity, 1 for number of views, 2 for whether it's a one-time event, 2 for how many users have added the event to the their wish list. Then a weighted average is computed resulting in an overall score between 0 and 1. We then normalize the number to between 0 and 10 to display it to users in a range that is easier to understand.

For movies, the venue rating works a little differently, given that the same movie can be playing at multiple theaters/venues. We calculate the venue rating for movie theaters by how many showings there are in that theater, so the one with the most showings in a day gets the highest score of 1. This highlights popular movies. We also look at which movies are playing at art house theaters with high ratings, so that less popular art house movies are measured by a separate factor, and can also be highlighted.

The venue score can be initially set by manual input, and then dynamically updated based on popularity in the community. A venue that has higher buzz events should in turn have higher venue rating. This will in turn result in higher buzz levels for future events.

Time is also an important factor in our system: for example a more recent view or pick can be weighted higher than an earlier one. This allows new events with fast-growing interest to be listed higher than one that has overall more views but less interest recently.

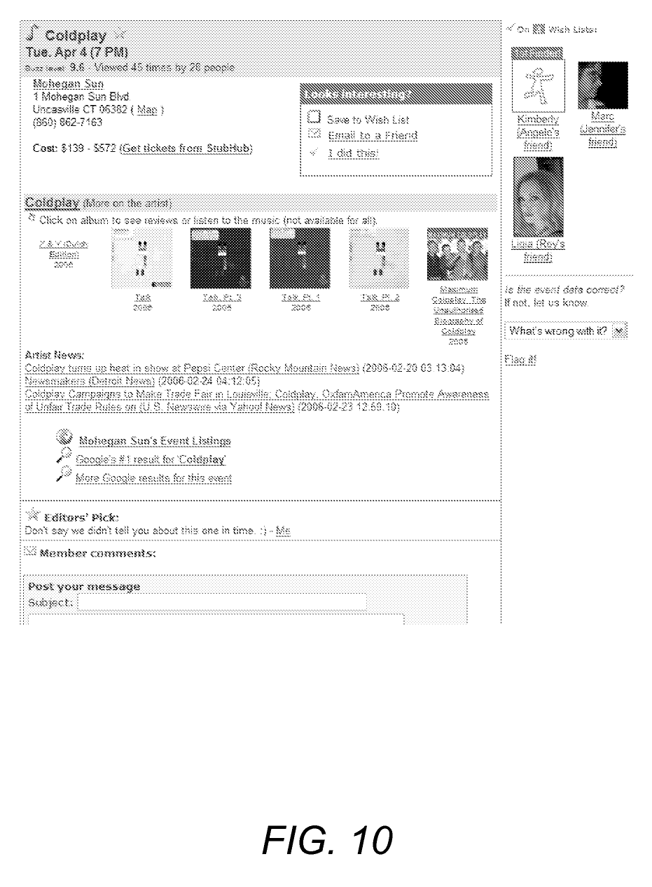

Clicking on an event in the listing shows more details about the event, as shown in FIG. 10. For each event, we show
Name, start and end date, time, buzz level, how often viewed and by how many people
Specific days/times the event is occurring, such as for ongoing plays or showtimes for movies
Location, address, and link map
Cost and link to buying tickets
Ability for user to add the event to his Wish List, done list, or email it to a friend (in blue box).
Description text aggregated from multiple sources
Artist info (see description below)
Links for additional information (see description below)
User comments
Which users have selected the event and put it on their wish list (on the right)
Allowing users to flag incorrect information for the event (on the right)

The system shows a link for the venue's event listing page (either extracted from external data feed or added by hand) and then adds links for searching on either the venue name or a combination of event or venue names for additional information. (The latter because just searching on event names alone often returns many extraneous results.)

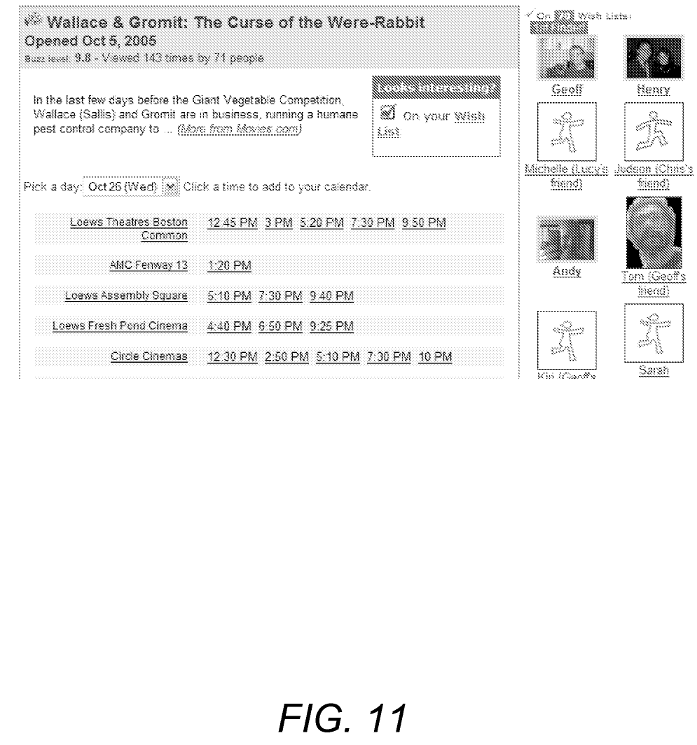

Movie display is slightly different from general event display because there are many locations and many movie times. As shown in FIG. 11, for movies we allow user to pick a date, and based on the selection, list the theaters showing the move and the showtimes.

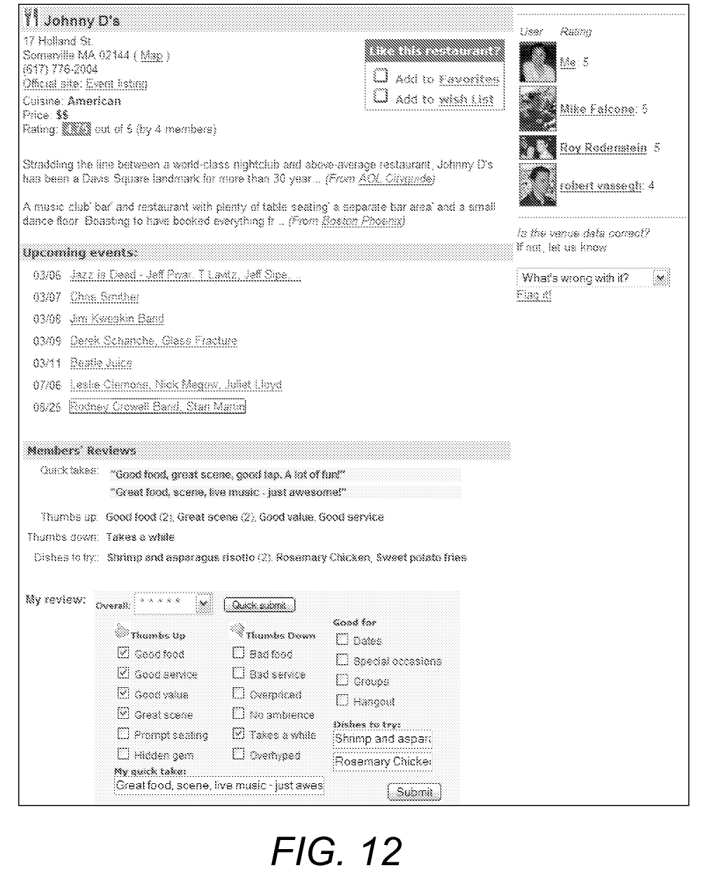

Clicking on the venue name link from either the Event Page or the Movie Page will bring up the Venue Page, as show in FIG. 12. This page displays venue location, map link, official site, venue descriptions from external data, and overall rating.

More importantly, in the second section on the left, it shows all the upcoming and potentially past events for the venue. This is useful for finding other events of interest, and helping user to get a sense of the location for the current event. The third section shows members' reviews including what's good or bad about the place.

Users can interact with venues in a number of ways, including rating them, reviewing them, selecting them for their Wish List, selecting them as favorites, posting messages. Restaurants have deeper options for user reviews, including the ability to input some dishes to try as well as descriptors, such as Good Food, Hidden Gem, or Great Scene. The number in parentheses denotes how many users have selected the same descriptor. The gray box at the bottom of FIG. 12 shows the interface for reviewing the venue. We have designed a very simple and informative restaurant review interface to encourage users to easily review restaurants. It contains an overall rating, some quick checkboxes, a one-line quick take, and two fields for dishes to try. Rating for clubs, movie theaters, museums, and art galleries use the same approach, with a few relevant descriptors.

As with the event page, the user can add a venue to his Wish List, so friends can easily see that both are interested in it decide to go together. The user can also add a venue to his favorites, which helps the user to keep track of places he likes and want to tell friends about; it's also a way for others to learn what a user likes as a part of our automatically generated user profile. On the right are detailed ratings and ability to flag missing or incorrect info for the venue.

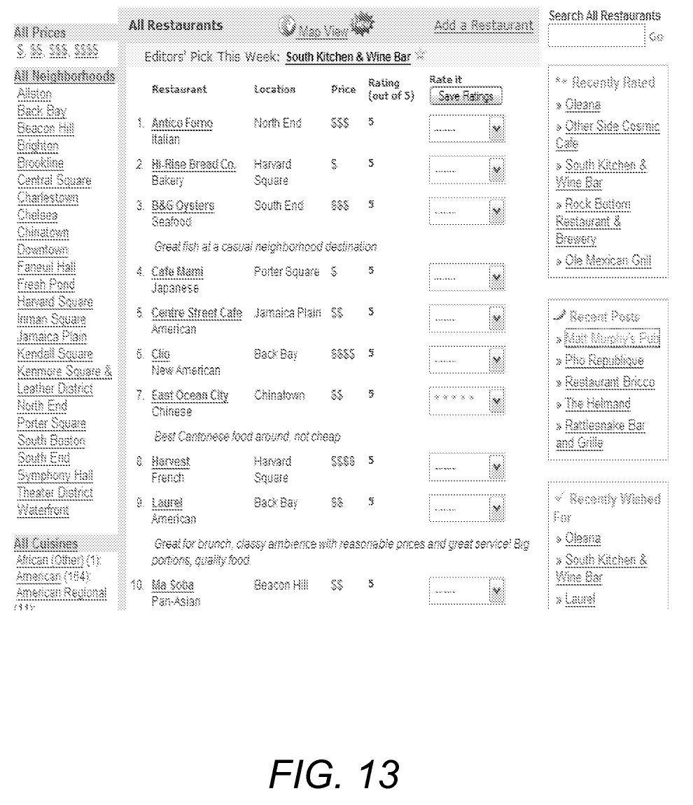

The user can also look at all the restaurants using the Restaurants Page, shown in FIG. 13. It's similar to the Events Page in that there are filters on the left hand side, in this case price, neighborhood, and cuisine. In the middle are listed the restaurants which fit the user's selected criteria. The ordering applies a formula that takes into consideration both average user rating and number of users who have rated it, since the more raters the greater the confidence in the overall rating. Additional information for the restaurants are shown, such as location, price, and rating. We allow users to rate restaurants right on this page. This way, they can easily select all the restaurants in a particular neighborhood or a particular cuisine and rate the ones they know all at once.

One problem that users often face is that there is not enough information for them to decide whether an event is worth going, even after we pull together descriptions from multiple sources. One solution we provide is showing more information on the artist who is performing at the event. Referring to FIG. 10, on the event page we show artists' recent or popular albums and latest news. The latter can be gathered from Web service calls to news services with the artists' name. The graphics and album information can give the user a better sense of the artist and remind them of his popular works. Clicking on the album can take the user to external pages where there is more information such as reviews of the album or previews of songs the user can listen to.

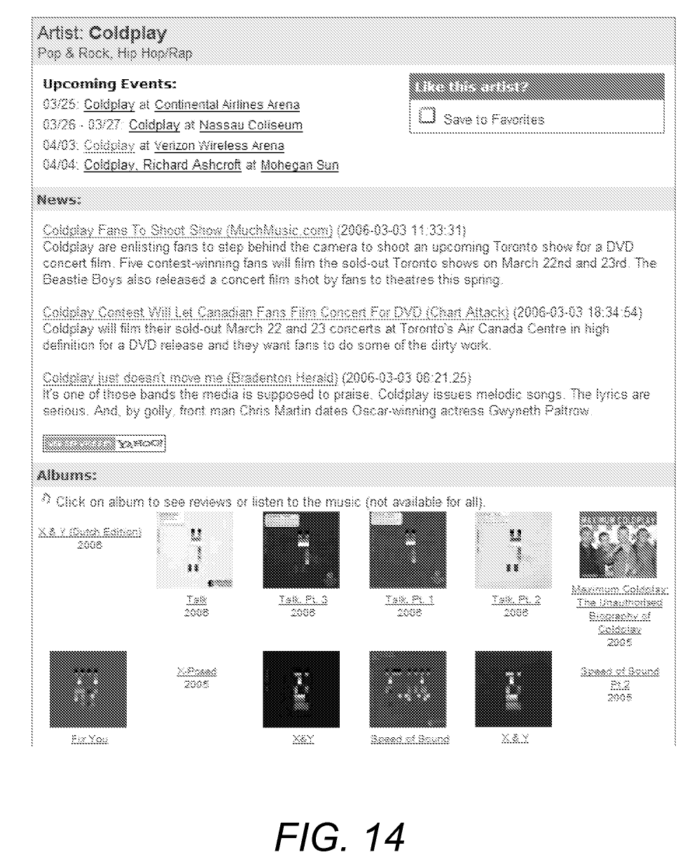

Clicking on the Artist name from the Event page takes the user to the Artist page, shown in FIG. 14. This displays more information on the artist, such as artist genre, which we deduce from the subcategories that an artist's events are categorized as such as Pop & Rock or Jazz, upcoming concerts to help users figure out other events they can catch the artist at, news clippings, and all of the artist's albums. The user can also save the artist to their favorites list.

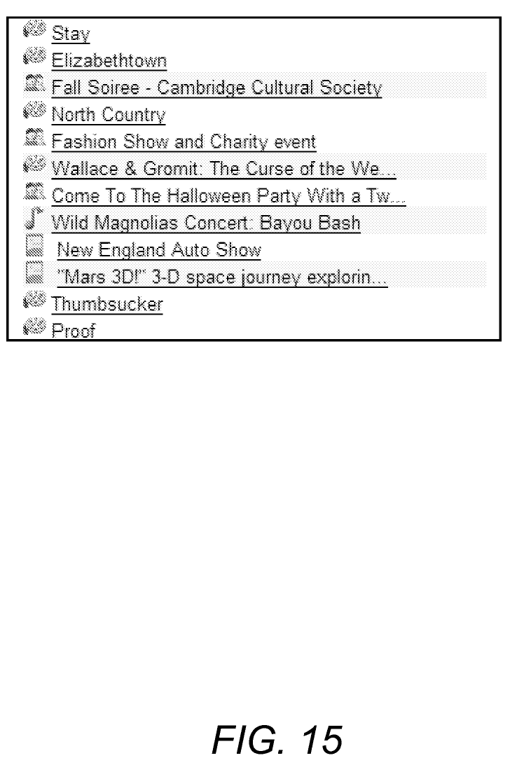

As alluded to earlier, our system offers a Wish List feature where users can select items they find interesting and save to that list. This allows them to easily save events, artists, or venues they like and get automatic reminders. But more importantly, a user's wish list can be shared with friends, so that friends can see what events each other is interested in, as shown in FIG. 15. The shared Wish List has several benefits:
Find interesting things to do—by checking what's on friends' wish lists, essentially using their friends as a filter for the hundreds of listings out there everyday
Learn what's popular—by allowing the system to display items that are most often on people's wish list
Learn friends' plans and availabilities—no need to call all the friends to see what they are up to as one plans the evening/weekend, events they plan to go to can be seen through their Wish List all in one place
Find people to do things with—rather than mass-mailing friends, users can directly call a couple of friends who already expressed interested in the same movie or event that they want to go to
Learn friends' interests—Users can see everything a friend is interested in one place
Meet new people—by finding others who have similar interests

The wish list can be implemented by keeping a relational database table of which user has selected what item at what time. For invites where people RSVP by answering Yes, No, Maybe where there's a similar table listing users and their responses, which we use to map it back to the wish list by mapping yes and maybe to a wish list selection.

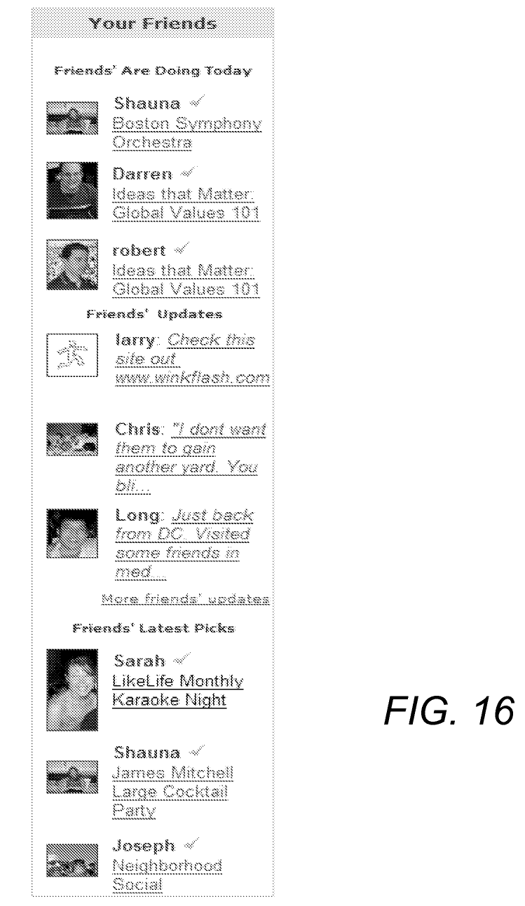

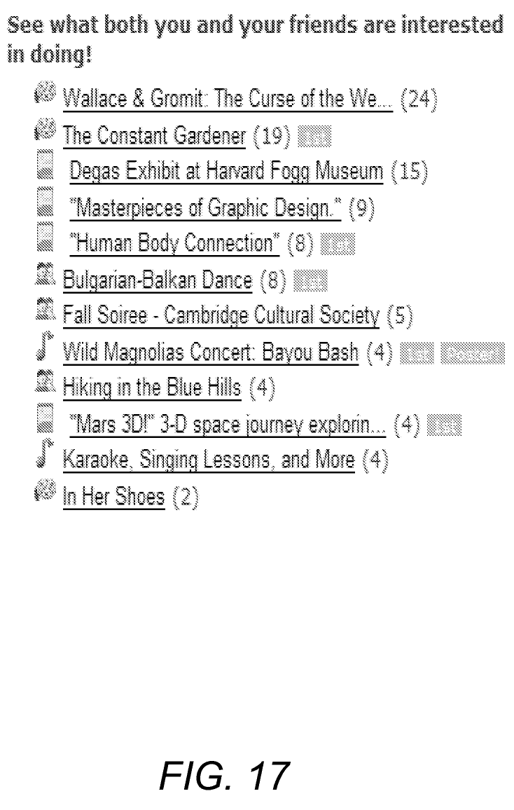

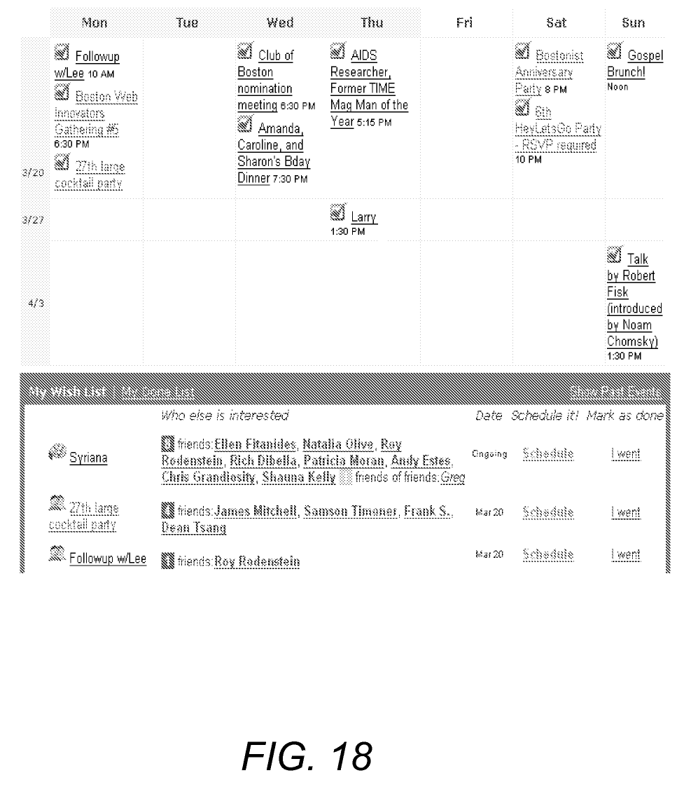

The wish list is displayed or taken into consideration in several places addressing the different types of needs above
Friend's Wish List—showing events in common, see FIG. 15.
Event page—showing who has selected the event on their wish list. See FIG. 10 and FIG. 11, on the right hand side.
Even listings—Wish list selection is an important factor for the Buzz Level calculation
User Profile page—part of a user's profile, see more below in the Friends Network section.
Friends are doing today on the home page—showing friends' wish list items for today, see top section of FIG. 16
Friends' Latest Picks on the home page—showing the latest picks from friends, see last section of FIG. 16
Friends' Top Picks—showing the top picks among friends, see FIG. 17.
Wish List & Calendar view shows the wish list items in a calendar, and below that details about each item on the wish list, as well as which friends have selected it. This is useful for planning events to go to based on interest among friends (FIG. 18). The calendar is described below in more details.

Similarly, our system offers a Done List feature where users can specify which events they've gone to. As they select “I went” on an item, it's also a good time to ask for ratings and comments. The done list can be implemented by keeping a relational database table of which user has indicated having done what item at what time.

Often a given member will be interested in other users' Wish List. Friend's picks are inherently relevant to the social life of a member; one member may also notice that another user often finds events of interest to him. In both cases the member may desire to stay up to date on the target user's Wish List, to make sure they don't miss out on potentially interesting events.

The member may wish to subscribe to a particular user, in order to always get notifications when that person has a new event on their Wish List. We support this functionality in several ways:
1. RSS feeds: We allow users to turn on RSS publishing of their Wish List, to allow others (even external parties) to subscribe to their Wish List.
2. Alerts for Wish List Selection: This feature displays notification when the person the subscribe to adds to their Wish List, by displaying a message to them with the trendsetter's name and the new Wish List item. Optionally e-mail notification is supported as well.
3. Subscribe to Wish List: on the home page where top events are displayed, e.g. FIG. 7, add section for Wish Lists You've Subscribed to, showing all the wish list items from people who the user has chosen to subscribe to.

Personalization means showing events for a given user based on their interests, whether expressed explicitly or implicitly. The system allows users to explicitly specify the categories of events such as Music-Blues that they are interested in. Then events that are in that category are more likely to be displayed to him, such as by considering this factor in a personalized buzz level calculation.

Implicit personalization, such as through collaborative filtering, can actually be more effective. We can use the fact that users who have expressed interest in the same event also expressed interest in other events to suggest events to a user. One shows interest by for example looking at an event (weighed less), by adding it to his wish list (weighed more), or by adding it to his done list (weighed even more). Typical collaborative filtering techniques such as nearest neighbor computed through Pearson correlation coefficients can be used. What's different here is that there are three measures of similarity as mentioned above. For example, we can use a score of 1 for having an item on the done list, 0.75 for an item on the wish list, and 0.25 for having viewed an item. Once the nearest neighbors are computed, we can then obtain the weighted average recommendations, again weighing each factor differently. In addition, because one tends to have similar interests as one's friends, we can weigh friends' recommendations higher than friends of friends, and so forth. Alternatively, if we want to bring to users' attention events not well known in their circle, we may weight non-friends higher than friends.

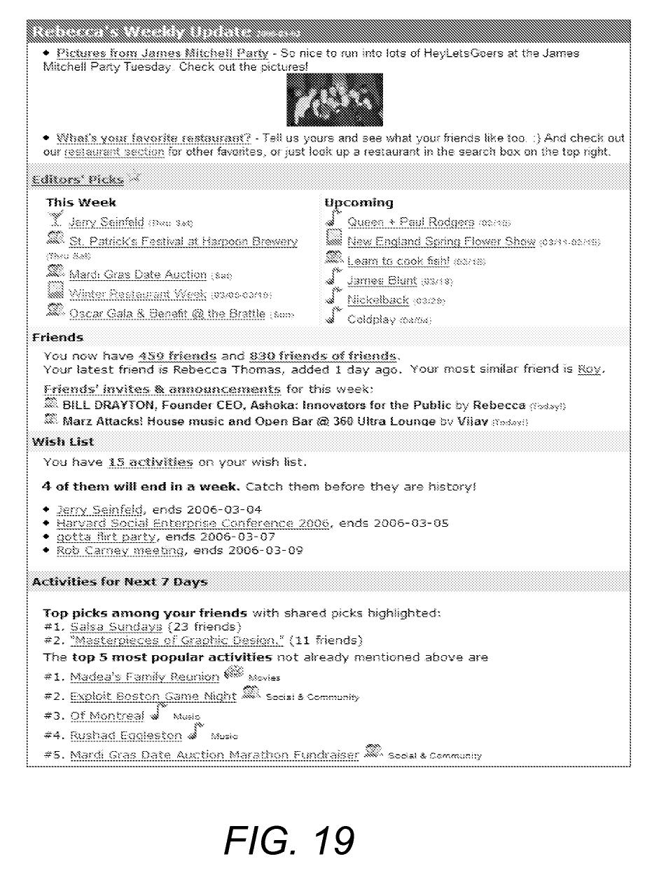

Social life planning is an ongoing, recurring task for people. Our system sends out a Personalized Weekly Update email (see FIG. 19) to help users find interesting things to do and make plans. The update includes
Announcements—of new features, interesting editorial picks
Editorial Picks—selection of interesting events by our editors
Events in their Wish List that are about to expire—to remind users
Events posted by their friends
Friends' top picks—based on which ones are added by the most number of friends to their Wish List, to help identify interesting events
Most Popular Picks
Top picks personalized for them—based on stated interest, past interest and other techniques as described above
Updates on friends—more in Friend network section
People to meet—new people one may be interested in getting to know

While many event systems send out updates, they are rarely personalized based on users' interests, beyond basic parameterization based on metropolitan areas and checked categories. Our system has much more detailed information to allow us to do better personalization. Our reminders are based on events users already expressed interest in. The top picks are personalized based on what users have indicated they already like. The friends' picks are unique because current event systems do not know about ones' friends. Events posted by users' friends is another unique feature of our Personalized Weekly Update. Currently people tend to send only a small number of emails announcing events, typically their own parties and a few really good events, because they do not want to spam people. This means friends can miss telling each other about an event because they do not know the others are interested. Our system makes it easy for friends to post all the events they want to tell others about (and even email a few they know for sure are interested). Then, on a weekly basis, each user can get a summary of all their friends' event postings for the next week, personalized so they are most likely to see what they will be interested in.

To avoid duplication, we keep track of events already shown to user in an array, and do not show it again in the same email. For example, if Editor's Picks include item A and Friends' top picks include item B, then in the Top 5 most popular picks section towards the end of FIG. 19, which selects items based on buzz level and possibly stated and implicit interest, if A and B are among the top 5, they'll be skipped.

The next part of our system deals with people, i.e., the friends network 108. Users can create a profile with basic personal information. They can also further specify their friends, similar to existing social networking sites like Friendster, MySpace, LinkedIn, and others. They can join groups and invite other friends to the site. They can also post public comments and send private messages to each other.

An important distinction is that we focus on creating connections between users through both online and offline interaction. So part of the user profile is the wish list of events they like, favorite venues and artists, as well as categories of events they like. These pieces can be used for personalization of event listings to help them identify events they'd like to do, as well as for others to learn about the user's interests.

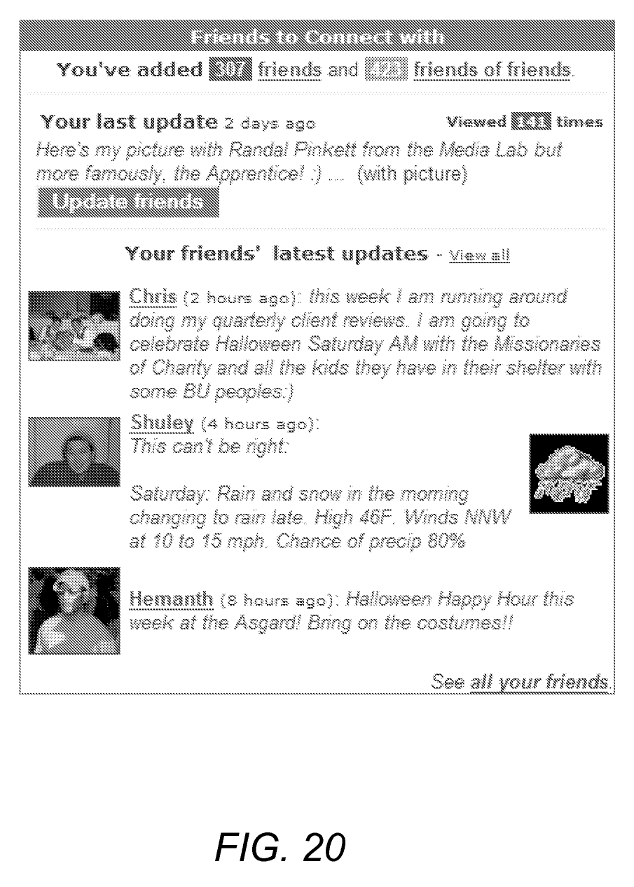

A key feature is the ability to update friends. The user can enter a few lines of text about what he's done recently or his plans for the weekend, and add an optional picture. This update text and picture will then automatically show up on all his friends' home page, as shown in FIG. 20, or in an abbreviated manner in the middle section of FIG. 16. This way, any time a user logs in, he can easily see all his friends' updates in one place, and can also update his friends in turn. It's much more light-weight than using email: people generally won't want to email friends about having gone to an outdoor concert over the weekend, because it's not “important” enough and people don't want to spam their friends with frequent updates.

This is implemented behind the scenes by two relational database tables. One keeps track of the user, time of update, and the actual text, and the other the picture for each update. Then based on friend connections, it's straightforward to pull out the appropriate latest updates form friends.

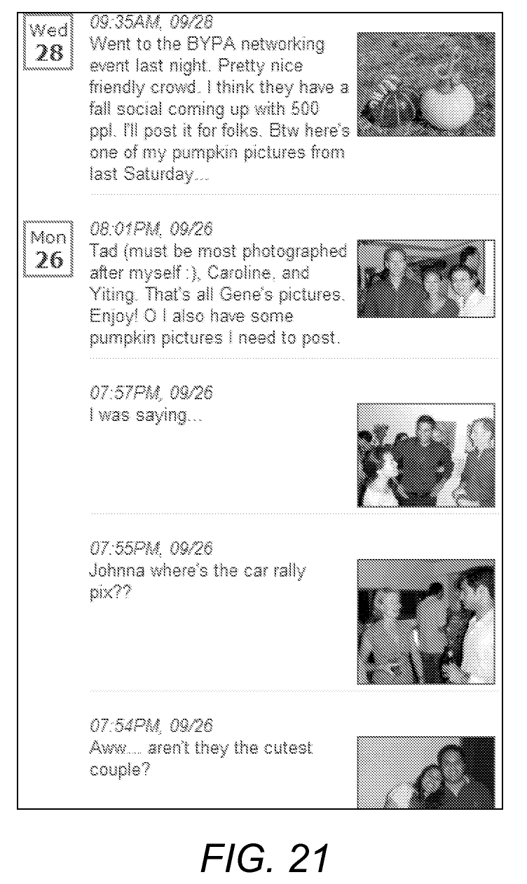

All a user's updates can be displayed together in an Update Blog, as shown in FIG. 21. So the user can keep a record of what he has done, and friends can catch up on all that's happened. This way a user can make as many updates as he likes and his friends can read them at leisure. It's much more lighter-weight than standard blogging, where people tend to write thoughtfully at length. Our updates are specifically designed for quick updates and ease of use by non-technical people. Notice how in the bottom half of FIG. 21, the updates work like captions for each picture, when sharing multiple pictures from say a party.

The update and update blog features are useful even for friends who are not in the same area to stay in touch with each other. For friends in the same area, it has the benefit of keeping friends in touch even if they don't do things together for some time, so that when there are opportunities, they feel connected enough to go do things together.

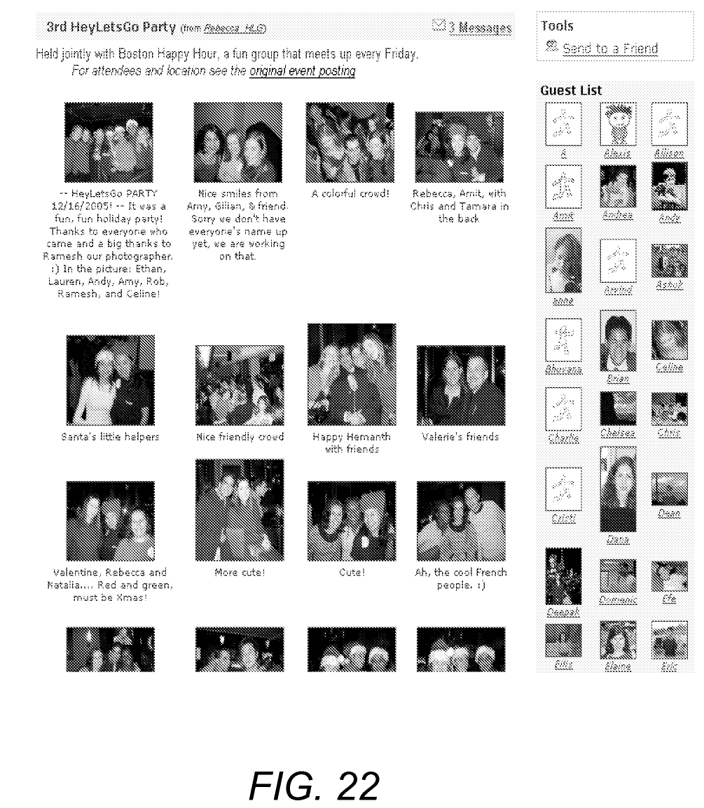

The pictures can also be shown in a photo album form, as shown in FIG. 22. A few additional pieces of information such as album name and description can be easily added. The album can also be easily shared with friends, by selecting a friends' email or entering a new email. Alternatively the updates and the top picture from the album can also be displayed in a calendar view.

By specifying an event or invite associated with the album, we can even display guest list for the party, useful to connect people who briefly met at the event. See the right hand side of FIG. 22. If new users sign up at an event, their accounts can be created with an association to that event's record on the site, so that they can also appear in the list even if they were not originally on the RSVP list.

Our system is useful for a user finding events to do, but can be much more useful when his friends are also using the site. They can easily arrange things to do, post events to let their friends know about them, or update friends on what's going on in their lives. The system offers several means for building friend connections on the site that represent real connections among existing friends. Partly this is done by making it easy to invite friends to the site, in which case we automatically add the invitee to the inviter's Friends list, partly this is achieved by adding connections among people once they've already joined the site.

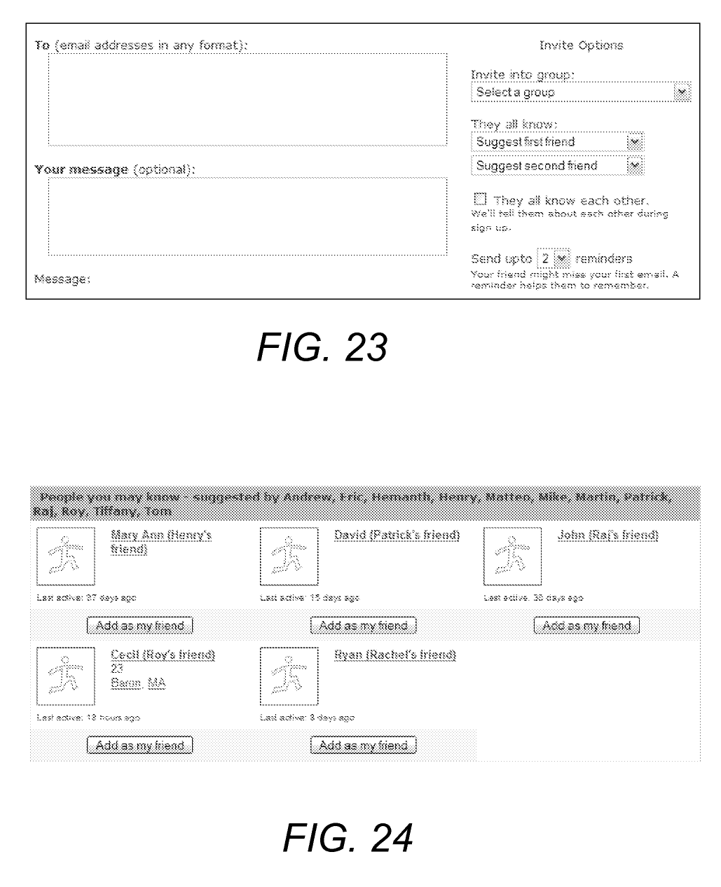

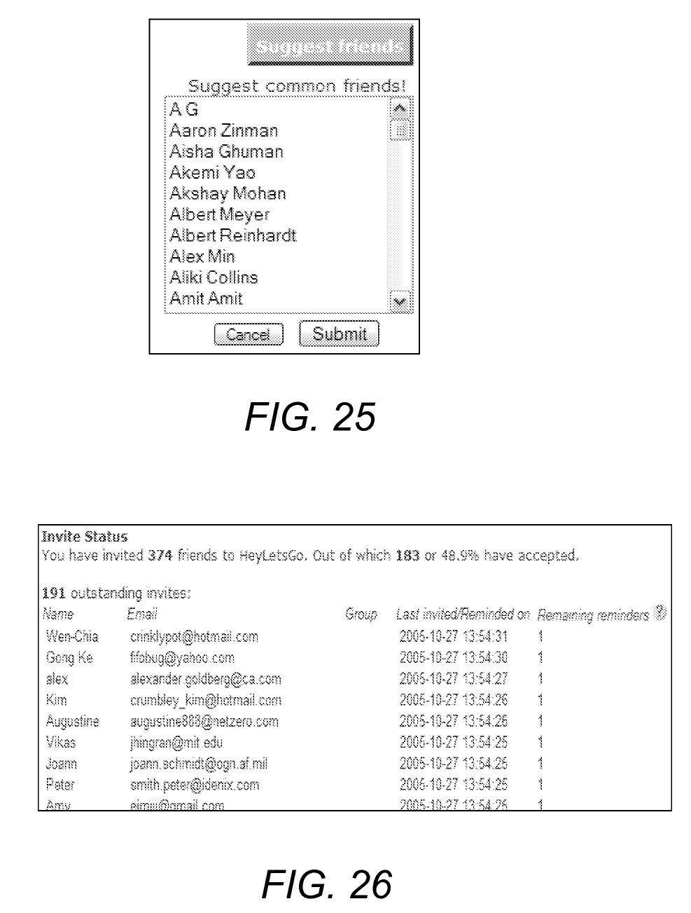

Methods include:
1. Suggesting friends when inviting a new friend—When inviting a friend, allow the user to identify other friends for that friend Then when the friend signs up, show the suggested friends for him to send a friend invite to. Alternatively we can create the friend connection automatically. This is done by two menus shown in the “Invite Options” panel on the right of FIG. 23. They each contain a list of all the user's friends for him to choose from. FIG. 24 then shows how the suggested friends are displayed to the newly joining user when he signs on. For each suggested friend we can also indicate who suggested them.
2. Inviting a group of friends together—so as to suggest them or connect them all to each other when they log on. See FIG. 23, right side. The checkbox allows users to specify whether they know each other, and should therefore be told about each other to facilitate those connections being established in the system.
3. Invite a user to a Group—Specify a Group in our system—such as NYU Alumni, Tennis Players, or Boston Young Professionals' Association—while inviting friends so add another way for people to look up people they already know in that group. See FIG. 23, right side. Again we can either make that a suggestion or automatically add them to the group.
4. Suggest a friend to a user—Allow a user to suggest friends to a 2^{nd} user who has already signed on. This way, someone who is new to the site can get help from friends who know about other friends on the site to more quickly build up a friend network. This is done through the Suggest friends button on the target user's profile. When clicked, it shows all the friends of the user currently viewing the profile and allows him to suggest friends to recommend, as shown in FIG. 25.
5. Friend invite status report—We show users the status of their invites, including how many people they have invited, how many have accepted the invitation to join, and who still has not accepted the invitation to sign on. This helps them easily see whom they have invited already, and who may need to be reminded (FIG. 26).
6. Invite codes—We allow special codes to be created such that a user who signs up with a given code can be added to a group or be added as a friend to one or more users, or both. This is convenient for users who want to invite others outside our system, using their own email system, and perhaps send it to a large mailing list.

For example, any user who joins with the BYPA code might be automatically added to the Boston Young Professionals' Association Group as well as be added as a personal friend of that group's organizer.

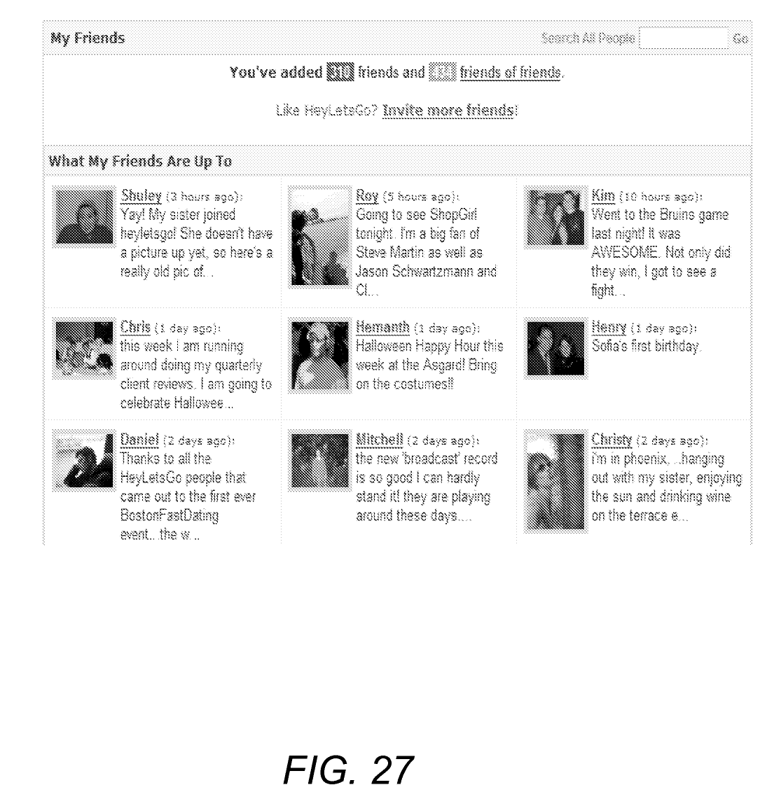

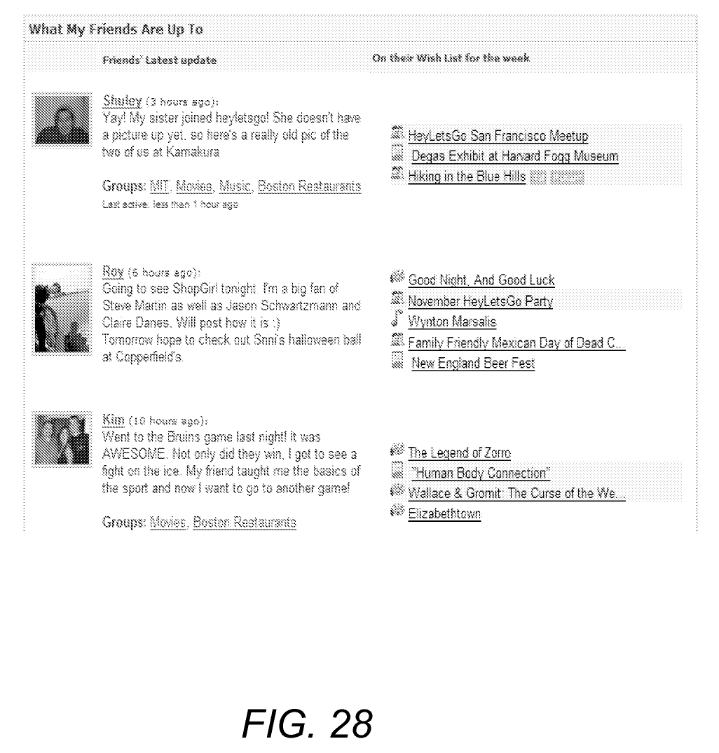

In the friends' view, we again emphasize the unique aspects of our site: easily view what friends are up to and what they are interested in doing. The compact view, shown in FIG. 27, shows friends' picture and updates listed by order of their updates. It's a useful way to get up to date with friends. The more detailed view shows each friend with their recent update as well as items on their wish list, with items in common highlighted, as shown in FIG. 28. Also useful for planning one's day is to see what each friend is planning to do for the day, see top of FIG. 16 for a simplified version for today. That way the user can decide to join friends or do something on his own. This can be done in more complete form by listing, for a given day, each event that at least one friend is going to, and which friends expressed interest in going to that event. One can also list multiple days, for example Friday to Saturday, and show which events are happening each day and the friends going to that. This is fairly straightforward to implement for one-day events. For multi-day events that may also take place on a select day, a different icon should be used to indicate that a friend may decide to attend the event another day.

The weekly update can also contain friend information, such as a collection of friends' updates, number of friends, friend requests outstanding, suggested activity partners, etc. Getting a collection of the latest friends' updates is particularly nice, to enable friends to stay in touch with each other without spamming or having to actively remember to come to the site to look at updates.

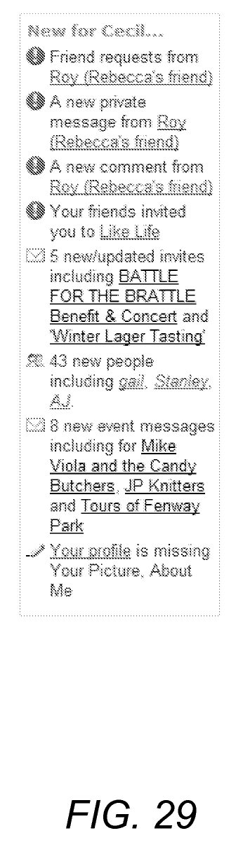

Users tend to vary in the frequency with which they log in to the system, depending on how busy or engaged they are. To help them keep up with recent activity that may interest them, the system includes New for You notifications. These are displayed on the home page in a highly visible area, as shown in FIG. 29.

The notifications make it easier for users to quickly find interesting activity they want to review, and also helps them to not miss important notices such as friend requests. They are personalized, highlighting what is new and important for each particular user. They also benefit the system in increasing users' responsiveness and engagement, strengthening the community.

There are several different types of notifications, including the following:
1. Friend request alert, including a link to the user that has requested friend status
2. New private message alert, including a link to the sender
3. New public comment alert, including a link to the sender
4. New replies to the user's messages to another user, including the name of the user replying and a link to the message
5. New replies to the user's messages on a group message board, including the name of the user replying and a link to the message
6. New replies to the user's messages on an event message board, including the name of the user replying and a link to the message
7. New friends, who have accepted a friend request or joined via the user's invitation
8. Suggested friends, including a link to the suggested friend's profile
9. New pictures for friends
10. New Wish List items for friends
11. New Updates from friends
12. Invitation to a group alert, including a link to the group the user is invited to
13. New or updated invitations to events posted by community members, with links to each
14. New members, including the total number and links to them
15. New messages for events, with the events named and linked to the message
16. New messages for groups, with the group named and linked to the message
17. New groups, with the group named and linked to the group
18. New members for groups, with the group named and linked to the group.
19. Missing profile information, including missing picture and self-description information.

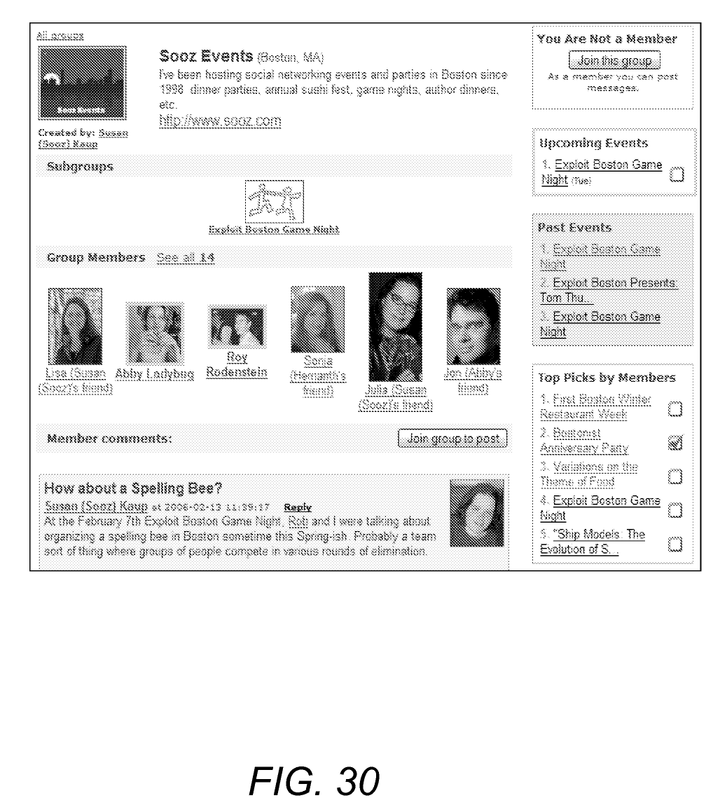

Groups are aggregations of people, and are another way users can find other people of interest (other typical ways are through friends, search, and random browsing of users). Groups can be based on affiliation (such as which school one goes to/went to -NYU Alumni-, or which neighborhood one lives in -SoHo-) or on interest (such as tennis). Groups are important both as a way to help build connections among people and as a channel for getting events of interest. Groups can be public, meaning anyone can join, or require moderator approval to join, or be by invitation only. Groups can also be used to support existing organizations of people for doing certain events, for example a weekly happy hour group or a group interested in meeting up to play soccer. Features for groups include events specific to that Group, Upcoming Events and Past Events calendars, message boards, member listings, polls, ability to message people in the group (by moderator or group members) with optional notification by e-mail, photo albums, group administrators and sub-groups. A sample group page is shown in FIG. 30.

Our system makes it easy to invite people into a group. We mentioned above how we can allow a user to invite others to join a group on the site. In addition, a user can also suggest the group to friends: select friends to invite from the group page or selecting groups to suggest from a friend's profile page. The system can also recommend groups to a user based on email (e.g. MIT for mit.edu) by heuristics or using suffixes provided by the group's creator. Also the system can show the most popular groups among friends or among others in the same local area. Each user's profile shows logos of the groups they belong to, which automatically enriches their profile with relevant information about them, and also helps users to find groups to join.

When posting an event, the user can pick one or more Groups to make the event visible to- see the group menu in FIG. 4. Either the owner/moderator of the group or any member can post events (of course the moderator may choose to not allow member postings). These events can be made visible either just to its members or to the public. FIG. 30 shows an example of a group's upcoming and past events listings on the left hand side. The past events are worth showing to give people an idea of the types of events a group has done. Note how the Past Events are shown in gray, while the Upcoming Events are highlighted with a red border and has check boxes for users to easily add to their wish list. One can also look at top picks by group members as another source of events of interest.

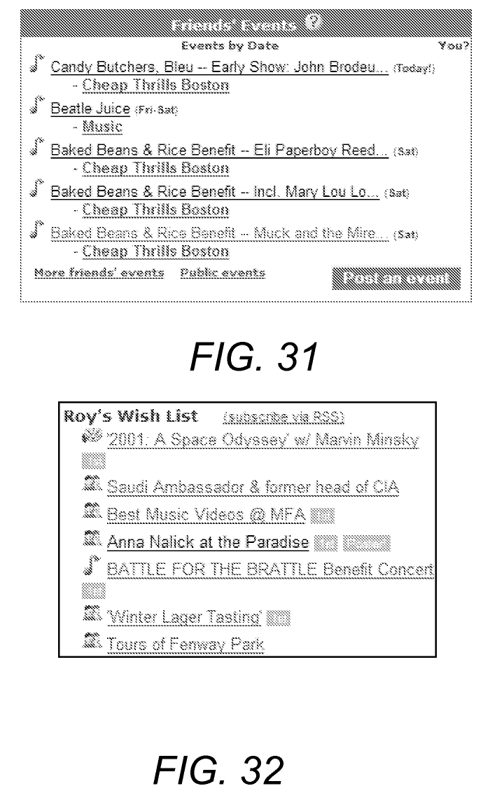

More importantly, Events for the group are also added to group members' friend-posting box on the front page. This allows user to have one place to view events posted by their friends and from groups they belong to. See FIG. 31, which is another implementation of the top events mechanism shown in FIG. 6 and FIG. 7. Note the display of group name right below the event name.

Many community organizations, alumni groups, and social groups want to reach out to a broader audience, and maintain a Web site, but have limited technical resources. The site often consists of mostly static content and organizations lack the ability to quickly update content. Group events get out of date, while group leaders lack means to make announcements on the site easily, and members and prospects are frustrated at missing events and not being able to interact with other members. Our Web site can serve as a rich member interaction front end that allows these members to post detailed profiles, build friend connections, and interact with each other. They can also post events to the Group and exchange messages with the whole group. This content can in turn be used by the group's Web site. It can simply point to our Group Page for dynamic content, or alternatively it can use our site as a backend and obtain RSS feeds of event listings, messages, user blogs and reformat the information in a manner that best fits the Web site.

It's essential to build a sense of community on the site to encourage users to connect more openly with others. To that end, we encourage users to become community leaders, either by organizing events and creating groups, or by designating them as “facilitators”. A facilitator is a social person who enjoys helping others feel comfortable. If a user's going to an event, such as an art show, it's helpful to know someone to go together. For someone who doesn't have a friend interested in arts who'd go with him, it might discourage him from going at all. From using our site, if he sees a facilitator's going to the event, who's already committed to helping others, he will feel more comfortable contacting the person to see if they can go together.

We also allow people to be facilitators for certain categories, such as arts, local bands, etc. This way, even if the facilitator's not going to the same event, he can provide help on what's the scene like, etc. We also allow people to be one-time facilitators, for an event that he's more interested in and want to help new corners out with. Facilitators are represented by an icon and more detailed information on what he's willing to help out with.

In a community there are typically trendsetters and followers, and it's important to leverage the trendsetters' value. In our system trendsetters are users who post events to the community, and also who pick an event that many other users find interesting. We therefore reward trendsetters by highlighting them as the “Poster” or “1^{st} Finder” of an event, providing them recognition within the community (see FIG. 32).

In addition, we use this information to compute the reputation of each member in terms of their contribution as trendsetters, and we display a table of overall Top Trendsetter to further highlight and reward the top contributors as well as make it easier for other members to benefit from their Wish List. We utilize several inputs for computing member reputation:
1. Number and popularity of events they are the Poster for
2. Number and popularity of events they are the 1^{st} Finder for, that is, how many followers also picked a given item after the trendsetter first picked it
3. Frequency of contribution, including how often the member is active on the site, how often they post to message boards, and how frequently they add to their Wish List
4. Number of friends they have invited and signup rate, computed recursively

Reputation is also applied recursively, so that a member whose 1^{st} Finder or Poster events are subsequently picked by other members with high reputation receives a boosted ranking.

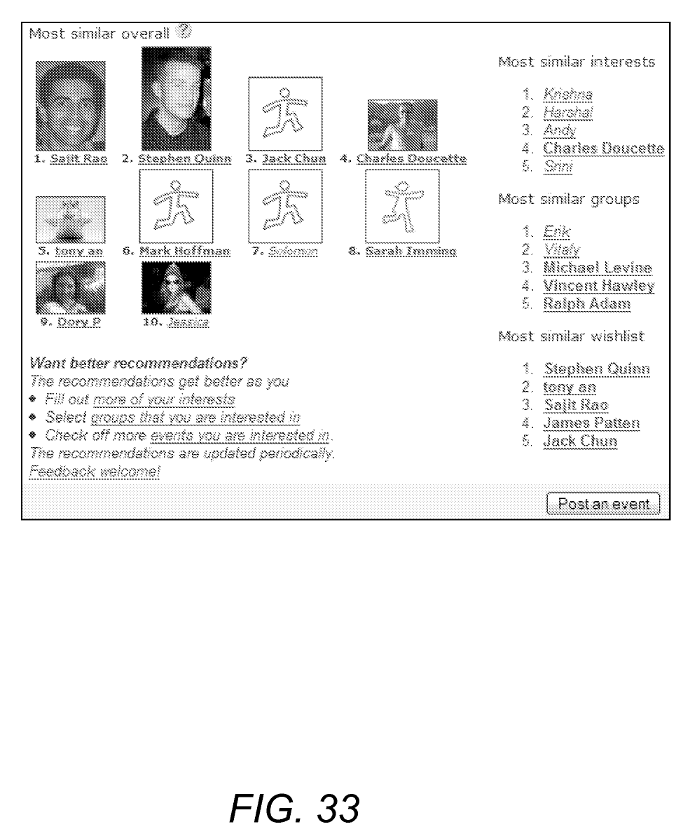

There are a number of other means for building a strong friend network. The system can suggest activity partners based on similar activity interests, such as by comparing their wish list, done list, groups they belong to, and categories of events they enjoy. See FIG. 33. The method for computing similar users is similar the event recommendation computation described above.

The system can also suggest friends by examining people connection data, such as number of friends in common, affiliation, and the like. Of course, it's even more powerful to combining activity interests with people connections in automatically recommending friends.

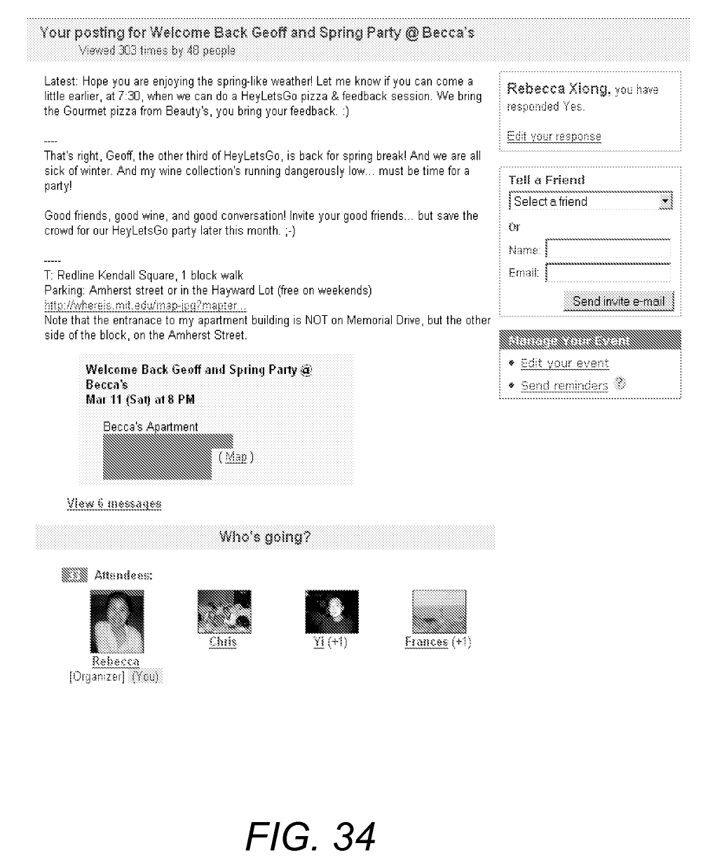

Having described the events and the people, we now turn to how people plan and coordinate around events. For system created events, users can easily create invites off of these, then track yes, no, maybe responses and coordinate. For example based on a popular museum exhibit, create an invite for a group trip to see it together. These can then be listed along with user-input new events and invites on the home page. See FIG. 6. FIG. 34 shows a sample invite page.

Answering yes or maybe to an invite will also result in adding the invite to the responder's Wish List. That way it's easy for a user to see what his friends are interested in either by looking at event listings to see who's going to them, or by looking at friends' wish list and seeing what they have selected.

The invite can also be made into a Public Invite with a URL that can be linked to from other Web sites or mailed out to a mailing list. Each user if not already a member of the site, can RSVP with their name. If already a member of the site or newly signed up, the user's profile will automatically be linked for others to view. All the guests can read or post comments, and after the event's over, view the associated album.

Moreover, we can visualize which friend is doing what during what time, which is useful for planning and deciding what one should do. One implementation is to have the people listed in rows, and events listed (time ordered) in the columns, then check off the cells if that person's attending or interested in that event. Another implementation has the events listed in rows, and the picture of each friend going to that event lined up for that row. This can help a user plan what to do based on both how interesting the event is and which of his friends are going.

Prior to creating an event, one would often like to poll for interest. This is supported in the system by a polling mechanism where one can list several suggestions, such as dinner, movie, or both, as well as suggested dates and times, and ask for feedback. Alternatively, one can post even less mature ideas on the message board for discussion.

Items in the wish list are also added to users' calendar, a social calendar of events a user will or would like to go to, see FIG. 18. We also allow users to add private events to their calendar, so that they can keep track of their non-working life in one place. This calendar can also be shared with a designated set of other users for event planning and scheduling purposes.

A lot of coordination is done ad hoc: one may decide to go to an outdoor concert at the last minute, and want to see who else is interested. We support this in the system by making it easy to notify a set of friends, such as by allowing users to create a buddy list for people they hang out with often, both on the site and otherwise, and automatically suggesting friends they typically invite together. We also allow users to create other groupings of friends, such as ones who are based in same city, ones who like music, etc. Ad hoc notification of interest in going to an event can then be done to a specified friend group through email or SMS.

We also create a Bored Tonight group that allows users to post last minute ideas or requests for things to do. Others can check the group page based on same interest to get in touch with others to do things together. Member of the group can also get optional email notifications. Similarly, an I'm Bored page collects ideas for what to do for a user: restaurants on his/her wish list, events on the wish list, favorite restaurants/venues, what friends are up to tonight, and friends on the “to touch basis” list.

In addition, the system can keep track of contact information for users, and allow the user to set rules for how they want others to access this info, such as show my phone number to this subset of my friends. It also allows people to more easily notify others, such as by sending SMS messages to event attendees. This allows people to contact others easily while on the go to notify others of changes in plans or announce new plans.

Getting tickets is often an essential step in going to an event such as a concert. Our system makes it easy for people to buy tickets online. First the system provides a link to the venue's official ticketing page, through automatic extraction via Web site crawling or optionally via manual input. If tickets are sold out, as is often the case for popular concerts, the system provides a link to secondary ticket sellers, such as StubHub and RazorGator. By aggregating multiple users interested in an event, our system can also collect money to buy tickets at group rates, or ensuring a group of friends can sit together.

Our system supports per-user RSVP to an event invitation. As an extension of this functionality, we assist the event organizer with ticketing and reservations (such as for a restaurant) for the whole group.

We support APIs that can return the number of confirmed (Yes, plus guests) or potential (Yes plus Maybe, including guests) attendees, for direct integration into ticketing sites such as Next Ticketing as well as reservation sites such as OpenTable.

In addition, we enable the organizer to gather payments from attendees through integration with PayPal and similar collection services, and display the payment status of each respondent, allowing the organizer to follow up with delinquent respondents or to exclude them from the ticket purchase or reservation as they see fit. Each respondent also sees their payment status along with a link to the account on the collection site where they can make their payment. Through this support we also enable organizers to apply for and secure group discounts.

While there are online marketplaces for products, through the likes of Ebay and Yahoo Stores which bring together sellers putting things up for sale with buyers looking for products, there is currently no good online marketplace for events. Event goers cannot easily find out about events they'd like to go to; event promoters have trouble reaching a larger interested audience.

Our basic system creates a strong network for event “buyers” and naturally attracts “sellers” in the form of event promoters, marketers, advertisers, and ticket sellers that together create an event marketplace. In addition, our system collects information about the event buyers that can be useful to the event sellers for better targeting.

This event marketplace built on top of the basic system consists of
An event promotion and targeting engine
An advertisement targeting engine
A ticketing metasearch engine

Event promoters can fill in the details for their events similar to a regular poster. In addition, event promoters can specify certain promotions, such as discount for people who see the listing from the Web site. They can also select who to promote an event to, such as based on
Age, gender, location or other demographic information
Membership in certain alumni or interest groups
Have viewed, selected, or attended a particular past event or categories of events within a certain timeframe—for example people who have attended previous events at the promoter's venue, who have recently attended events at a competitor's venue, or who have friends that regularly attend events at the promoter's venue.

By making their promotional listing more targeted, the event promoter can pay for fewer listing views while reaching a more interested audience. These paid listings supplement regular event listings, and are shown as more prominent listings with graphics and additional info as well as in a separate section for sponsored listings.

Alternatively, our event promotion engine can also automatically determine which events to promote to which users using an algorithm incorporating the factors listed above. Based on who has selected a particular event or looked at a particular event, we can calculate the demographics and interests of others who are likely to be interested in an event. We can also use collaborative filtering methods to identify others who might be interested in the event, and show the more prominent listing to catch the user's attention.

These two systems can work in conjunction: first event promoters seed the engine by specifying demographic parameters as well as related events and interests that they believe indicate that users interested in those events will be a good target for their promotion, then the engine will automatically adjust the parameters to maximize click through rates.

Events can be promoted to not just individuals but also a group of users. From simple membership in a certain group, to promotion to a group of friends who are closely knit and go to arts events together or have bought group discount tickets together. When there's not only an interesting event but also others to go with, an even can be far more interesting.

Based on users' expressed interest in events (through clicking or adding to Wish List), a certain set of events may be of interest that our system will list for them automatically in their personalized listings. In that listing, the events will be ordered based on relevancy or overall Buzz Level. If an event is less well known, it can be displayed much lower in the listing. By paying for a premium listing, the event promoter ensures that his event is much more likely to be viewed by a user.

To reduce the likelihood of spamming, the user can choose to block event listings or ads from a particular event promoter, or certain types of event listings (e.g. no sporting events or events costing >$20). They can also rate the event promoters in terms of quality of offering and truth in advertising so that poor-quality paid listings quickly get filtered out.

Advertisement targeting, such as U2 CDs for people interested in U2 concerts work in similar ways. Advertisers can specify who to target ads to based on the same parameters available to event promoters. When paying by impressions, it is thus to their advantage to be more targeted in their advertising so as to increase return on investment, and can also take advantage of our automatic advertisement promotion engine which works similarly to our event promotion engine, using information about what events do people who click on the ads tend to be interested in.

Once a user decides that they are interested in an event, they may need to purchase a ticket for the event. Our system integrates purchasing tickets by linking to the venue's ticketing area directly or, if unavailable, to the ticket agent that sells tickets on the venue's behalf for a given event. Often there are multiple options for purchasing a ticket, such as directly from the venue, through a ticketing agent like Ticketmaster or Next Ticketing that may charge different fees, as well as through secondary ticket marketplaces such as Stubhub and Razorgator.

In order to help users find the best price given these many options, without having to spend time going to each individual website, our system supports ticketing meta-search to directly show users the pricing available through each ticketing vendor. We use our event de-duping system to aggregate ticket pricing for the same event from multiple sources.

To show pricing, we use two techniques:
1. Pre-fetched data: For certain vendors, such as Stubhub, we have frequently-updated data feeds that include updated pricing data.
2. Live, AJAX-based fetching of pricing data: For other vendors, such as Next Ticketing or the venue's own box office, we don't have updated feeds so we perform live data pulls on demand for the user, utilizing asynchronous querying to load the ticket cost data into the browser dynamically without forcing the user to refresh their screen.

We combine these two techniques to display to users an update table of ticket vendors and their price range and ticket availability, along with links to jump to each vendor.

Our system is able to generate certain revenue from the site's content, such as by displaying contextually relevant advertising on event pages. At the same time, the system benefits from users contributing their own events via posting them.

In order to encourage members to post events and share them with the community, we have developed a mechanism for revenue sharing with members. Applying our click-through logs, our system computes the portion of advertising revenue attributable to each event by assigning it a share of overall traffic. These percentages can then be used to credit each contributing user with a portion of revenue according to the total traffic contributed by all the events they have posted.

The basic system with events, people and coordination capabilities can further be used for other purposes. With our basic system, we have created a strong network of users who return regularly to find events to go to, view updates from friends, and interact with other users. This network is valuable for other purposes, such as:
Dating, where we provide more social context for a given user to decide whom to date based on their circle of friends, interests, activities done, Updates, Groups, etc.
Asking for trusted friends' recommendations, such as for finding roommates, travel options, or services
Advertising one's services to friends and their friends

Several embodiments of the present invention have been described. Nevertheless, it will be understood that various modifications may be made without departing from the spirit and scope of the invention. Accordingly, other embodiments are within the scope of the following claims.

What is claimed is:

1. A method for providing online management of social and leisure life activities comprising:
providing a website wherein said website is accessible via a network connection and comprises a plurality of interlinked webpages stored in a memory and said memory is coupled to a computing circuit and to a communications interface for communicating via said network connection;
listing one or more events in an events database, wherein said events database is accessible via said website;
listing profiles of one or more users in a users database wherein said users profiles comprise information about said users, interests, preferred activities and network of friends and said users database is accessible via said website;
linking said events database to said users database based upon said users profile information; and
planning and coordinating one or more social or leisure activities for said users.

2. The method of claim 1 wherein said one or more leisure activities are planned and coordinated for a group of said users.

3. The method of claim 1 wherein said listing of events comprises posting events by users.

4. The method of claim 1 wherein said listing of events comprises gathering event listings from external data feeds.

5. The method of claim 4 wherein said gathering comprises crawling external websites, identifying event URL address, name, date, time, venue, event description and cost information, checking for a duplicate event and listing said event in said event database if no duplicate event exists.

6. The method of claim 4 wherein said external data feeds are selected from a group consisting of structured data feeds, unstructured data feeds, RSS and XML.

7. A method for providing online management of social and leisure life activities comprising:
providing a website wherein said website is accessible via a network connection and comprises a plurality of interlinked webpages stored in a memory and said memory is coupled to a computing circuit and to a communications interface for communicating via said network connection;
gathering event listings from external data feeds;
removing duplicate event listings from said external data feeds thereby generating unique event listings; and
listing said unique event listings in an events database, wherein said events database is accessible via said website.

8. The method of claim 7 further comprising assigning an identification feature to each event listing.

9. The method of clam 8 wherein said identification feature is selected from a group consisting of a URL address pointing to an event webpage, a number, a name and combinations thereof.

10. The method of claim 7 wherein said gathering of event listings and said removing of duplicate listings occur in real-time.

11. The method of claim 7 wherein said events database comprises event data organized in a canonical structure of categories and subcategories.

12. The method of claim 1 wherein said events are selected from a group consisting of concerts, live music, arts, cultural events, social and community events, sporting events, outdoor activities, recreational activities, professional and business events, and private parties and gatherings.

13. The method of claim 1 wherein said events database comprises listing of event name, time, venue, event description, cost information, artist background information, reviews, transportation information, proximity to other events information, links to additional information, user comments and recurrence information.

14. The method of claim 1 further comprising communicating with users listed in said users database.

15. The method of claim 1 further comprising inviting users to attend an event or a leisure activity.

16. The method of claim 1 further comprising assigning visibility privilege to each listed events.

17. The method of claim 16 wherein said visibility privilege is selected from a group consisting of public, my friends and their friends, my friends, select friends, select group, and private.

18. The method of claim 1 wherein said events are displayed in lists selected from a group consisting of today's events, next 7 days events, upcoming events, events posted by friends, events posted by group members, top picks, editor's picks, friends' picks, more for today, user's wish list, recommended based on user's interest and users group events.

19. A method for providing online management of social and leisure life activities comprising:
providing a website wherein said website is accessible via a network connection and comprises a plurality of interlinked webpages stored in a memory and said memory is coupled to a computing circuit and to a communications interface for communicating via said network connection;
listing one or more events in an events database, wherein said events database is accessible via said website;
listing profiles of one or more users in a users database wherein said users profiles comprise information about said users interests, preferred activities and network of friends and said users database is accessible via said website;
assigning a buzz level to each event, wherein said buzz level is a measure of the events popularity.

20. The method of claim 19 wherein said buzz level is calculated based on number of viewings, number of unique viewers, number of users placing the event in their wish lists, number of users making plans to attend the event, number of users having attended the event, ratings of the event, whether event is one-time or ongoing, and how soon it will be over.

21. The method of claim 19 further comprising prioritizing and displaying events according to their buzz level.

22. The method of claim 1 further comprising entering a rating for an event or a venue by said users.

23. The method of claim 1 further comprising subscribing to a specific user's wish list.

24. The method of claim 1 further comprising providing personalized events to a user based on the user's profile.

25. The method of claim 1 further comprising providing personalized events to a user based on collaborative filtering techniques.

26. The method of claim 1 further comprising providing personalized events to a user based on recommendation by a group of users.

27. The method of claim 1 further comprising sending e-mail updates to users.

28. The method of claim 27 wherein said e-mail updates comprise personalized event recommendations, generic event recommendations and update information about said users friends.

29. The method of claim 1 further comprising uploading text, images, and media files onto a users profile.

30. The method of claim 1 further comprising
identifying users with common interests; and
inviting said users to join a group with common interests.

31. The method of claim 1 further comprising introducing new friends to a user based upon said user's profile information.

32. The method of claim 1 further comprising providing means to a user to connect with other users attending an event, before, during or after an event.

33. The method of claim 1 further comprising assigning and displaying an affinity degree of a user to another user, wherein said affinity degree is based upon friends in common, groups in common, profile information and events listed in the user's wish lists.

34. The method of claim 1 wherein said event planning and coordinating for a group of users is done by a facilitator.

35. The method of claim 1 further comprising providing an online link to a ticket purchasing system for events.

36. The method of claim 1 further comprising providing a ticket engine for finding the best price from available ticket sites.

37. The method of claim 1 further comprising keeping track of users registered to attend an event.

38. The method of claim 1 further comprising promoting events to users.

39. The method of claim 1 further comprising providing advertisements to users.

40. The method of claim 1 further comprising providing dating services among users.

41. A system for online management of social and leisure life activities comprising:
a website wherein said website is accessible via a network connection and comprises a plurality of interlinked webpages stored in a memory and said memory is coupled to a computing circuit and to a communications interface for communicating via said network connection;
means for listing one or more events in an events database, wherein said events database is accessible via said website;
means for listing profiles of one or more users in a users database wherein said users profiles comprise information about said users interests, preferred activities and network of friends and said users database is accessible via said website;
means for linking information from said events database to said users database based upon said users profile information; and
means for planning and coordinating one or more social or leisure activities for said users.

42. The system of claim 41 wherein said one or more leisure activities are planned and coordinated for a group of said users.

43. The system of claim 41 wherein said means for listing of events comprises means for posting events by users.

44. The system of claim 41 wherein said means for listing of events comprises means for gathering event listings from external data feeds.

45. The system of claim 44 wherein said means for gathering comprises means for crawling external websites, means for identifying event URL address, name, date, time, venue, event description and cost information, means for checking for a duplicate event and means for listing said event in said event database if no duplicate event exists.

46. The system of claim 44 wherein said external data feeds are selected from a group consisting of structured data feeds, unstructured data feeds, RSS and XML.

47. A system for online management of social and leisure life activities comprising:
a website wherein said website is accessible via a network connection and comprises a plurality of interlinked webpages stored in a memory and said memory is coupled to a computing circuit and to a communications interface for communicating via said network connection;
means for gathering event listings from external data feeds;
means for removing duplicate event listings from said external data feeds thereby generating unique event listings; and
means for listing said unique listings in an events database, wherein said events database is accessible via said website.

48. The system of claim 47 further comprising means for assigning an identification feature to each event listed.

49. The system of clam 48 wherein said identification feature is selected from a group consisting of a URL address pointing to an event webpage, a number, a name and combinations thereof.

50. The system of claim 47 wherein said means for gathering of event listings and said means for removing of duplicate listings operate in real-time.

51. The system of claim 47 wherein said events database comprises event data organized in a canonical structure of categories and subcategories.

52. The system of claim 41 wherein said events are selected from a group consisting of concerts, live music, arts, cultural events, social and community events, sporting events, outdoor activities, recreational activities, professional and business events, and private parties and gatherings.

53. The system of claim 41 wherein said events database comprises listing of event name, time, venue, event description, cost information, artist background information, reviews, transportation information, proximity to other events information, links to additional information, user comments and recurrence information.

54. The system of claim 41 further comprising means for communicating with users listed in said users database.

55. The system of claim 41 further comprising means for inviting users to attend an event or a leisure activity.

56. The system of claim 41 further comprising means for assigning visibility privilege to each listed events.

57. The system of claim 56 wherein said visibility privilege is selected from a group consisting of public, my friends and their friends, my friends, select friends, select group, and private.

58. The system of claim 41 wherein said events are displayed in lists selected from a group consisting of today's events, next 7 days events, upcoming events, events posted by friends, events posted by group members, top picks, editor's picks, friends picks, more for today, user's wish list, recommended based on user's interest and users group events.

59. A system for online management of social and leisure life activities comprising:
a website wherein said website is accessible via a network connection and comprises a plurality of interlinked webpages stored in a memory and said memory is coupled to a computing circuit and to a communications interface for communicating via said network connection;
means for listing one or more events in an events database, wherein said events database is accessible via said website;
means for listing profiles of one or more users in a users database wherein said users profiles comprise information about said users interests, preferred activities and network of friends and said users database is accessible via said website;
means for assigning a buzz level to each event, wherein said buzz level is a measure of the events popularity.

60. The system of claim 59 wherein said buzz level is calculated based on number of viewings, number of unique viewers, number of users placing the event in their wish lists, number of users making plans to attend the event, number of users having attended the event, ratings of the event, whether event is one-time or ongoing, and how soon it will be over.

61. The system of claim 60 further comprising means for prioritizing and means for displaying events according to their buzz level.

62. The system of claim 41 further comprising means for entering a rating for an event or a venue by said users.

63. The system of claim 41 further comprising means for subscribing to a specific user's wish list.

64. The system of claim 41 further comprising means for providing personalized events to a user based on the user's profile.

65. The system of claim 41 further comprising means for providing personalized events to a user based on collaborative filtering techniques.

66. The system of claim 41 further comprising means for providing personalized events to a user based on group of users recommendations.

67. The system of claim 41 further comprising means for sending e-mail updates to users.

68. The system of claim 67 wherein said e-mail updates comprise personalized event recommendations, generic event recommendations and update information about said users friends.

69. The system of claim 41 further comprising means for uploading text, images and media files onto a users profile.

70. The system of claim 41 further comprising
means for identifying users with common interests; and
means for inviting said users to join a group with common interests.

71. The system of claim 41 further comprising means for introducing new friends to a user based upon said user's profile information.

72. The system of claim 41 further comprising means for a user to connect with other users attending an event before, during or after an event.

73. The system of claim 41 further comprising means for assigning and means for displaying an affinity degree of a user to another user, wherein said affinity degree is based upon friends in common, groups in common, profile information and events listed in the user's wish lists.

74. The system of claim 41 wherein said event planning and coordinating for a group of users is done by a facilitator.

75. The system of claim 41 further comprising an online link to a ticket purchasing system for events.

76. The system of claim 41 further comprising a ticket engine for finding the best price from available ticket sites.

77. The system of claim 41 further comprising means for keeping track of users registered to attend an event.

78. The system of claim 41 further comprising means for promoting events to users.

79. The system of claim 41 further comprising means for providing advertisements to said users.

80. The system of claim 41 further comprising means for providing dating services among said users.
